(19) United States
(12) Patent Application Publication
(10) Pub. No.: US 2002/0182578 A1
(43) Pub. Date: Dec. 5, 2002

(54) Online course support method and system

(76) Inventors: Bruce A. Rachman, Westfield, NJ (US); Bob W. Blevins, Austin, TX (US)

Correspondence Address: FULBRIGHT & JAWORSKI L.L.P., A REGISTERED LIMITED LIABILITY PARTNERSHIP, SUITE 2400, 600 CONGRESS AVENUE, AUSTIN, TX, 78701, US

(21) Appl. No.: 09/873,120

(22) Filed: Jun. 1, 2001

(51) Int. Cl. G09B 3/00

(52) U.S. Cl. 434/350

(57) ABSTRACT

Th+e present invention generally provides a course support system that among other things includes a course support server for providing to users an on-line course book. The course book content is provided in electronic reader files that allow the course book pages to be displayed to users substantially as they appear in a corresponding printed version of the course book. In addition, however, the on-line course book can have (1) links that allow a user to conveniently retrieve additional materials related to a currently displayed page, (2) a homework tool that presents the user with a writeable workspace for receiving the user's responses to homework exercises in the course book and automatically sending the completed homework to an instructor user without the student user otherwise having access to the instructor user, and (3) testing tools for presenting a student user with both practice and real tests that can be automatically scored and archived. The course support server can also implement various security measures to inhibit a user's ability to (1) surf the web when the course book is delivered through the Internet, and (2) copy or otherwise access course book content unless the user is actively logged onto the course support server.

### TECHNICAL FIELD OF THE INVENTION

The present invention generally relates to applications provided over a network. In particular, the present invention relates to an on-line course support method and system.

### BACKGROUND

Teachers commonly use traditional textbooks to assist in teaching students. For instance, a teacher may instruct students to read various pages of the textbook for homework, and then lecture the following day regarding the material that the students read for homework. Teachers also commonly use homework assignments, quizzes, and tests as teaching tools. For example, teachers may assign students homework problems, some of which may be contained in the textbook. Students then complete the homework assignments, and return their homework papers to the teacher. The teacher then may grade the homework assignment, and record the grade in a gradebook. Teachers may also administer quizzes and tests to evaluate the level of a student's knowledge. Students complete these quizzes and tests, and then return them to the teacher to be graded.

These traditional teaching tools have several disadvantages. For instance, when teachers assign reading assignments from textbooks, students are required to bring the textbook home to complete the reading assignment. This may be problematic as students may forget to bring the book back to school the next school day. Furthermore, information contained in textbooks may become outdated as traditional textbooks are often used by a school for several years before being replaced. As a result, teachers may often have to use additional material to supplement the information in the textbook.

Moreover, traditional homework and testing methods are very time consuming for teachers. It often takes a significant amount of time to grade homework, tests, or quizzes for an entire class. After the assignments are graded, the teacher must then record each of the grades.

Various electronic textbooks that are accessible over the internet have been proposed to address some of these problems. These electronic textbooks are advantageous in that they may be accessed by the student at home or in class through an internet connection. This may obviate the need for a student to carry a textbook between school and home. However, these existing on-line textbooks have many disadvantages. For example, many of the existing electronic textbooks are presented to the student in a format that is difficult to read and navigate. For example, in many cases, schools wish to have both traditional textbooks along with equivalent on-line corollaries. However, when the on-line versions are implemented in a conventional HTML format, it is difficult to make them appear like the traditional textbook. This makes it difficult for students to interchangeably use both the online and traditional course books. Furthermore, some of the proposed on-line textbooks are in a form that requires a significant amount of bandwidth in order for the student to access the textbook. Additionally, some existing on-line textbooks do not provide features other than allowing the student to simply views text over the internet. In addition, without effective security measures, on-line textbooks can be more readily copied, which can harm the publisher, as well as the integrity of a course (e.g., in connection with the a student's completion of a homework assignment).

Accordingly, a need exists for an improved on-line textbook solution that addresses some or all of the previously discussed problems.

### SUMMARY OF THE INVENTION

The present invention generally provides a course support system that among other things includes a course support server for providing to users an on-line course book. The course book content is provided in electronic reader files that allow the course book pages to be displayed to users substantially as they appear in a corresponding printed version of the course book. In addition, however, the on-line course book can have (1) links that allow a user to conveniently retrieve additional materials related to a currently displayed page, (2) a homework tool that presents the user with a writable workspace for receiving the user's responses to homework exercises in the course book and automatically sending the completed homework to an instructor user without the student user otherwise having access to the instructor user, and (3) testing tools for presenting a student user with both practice and real tests that can be automatically scored and archived. The course support server can also implement various security measures to inhibit a user's ability to (1) surf the web when the course book is delivered through the Internet, and (2) copy or otherwise access course book content unless the user is actively logged onto the course support server.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram showing one embodiment of the course support system of the present invention.

FIG. 2 is a block diagram showing one embodiment of a course support program in connection with a database server of the present invention.

FIG. 3 is a flow diagram showing one embodiment of a partial routine for implementing a course support program of the present invention.

FIG. 4A is a flow diagram showing one embodiment of a partial routine for implementing a homework engine of the present invention.

FIG. 4B is a flow diagram showing one embodiment of a partial routine for implementing a test engine of the present invention.

FIG. 4C is a flow diagram showing one embodiment of a partial routine for implementing a course support program security technique of the present invention.

FIG. 4D is a flow diagram showing one embodiment of a partial routine for implementing a course content file security technique of the present invention.

FIGS. 5 through 28 show exemplary screen prints from a course support system of the present invention

### DETAILED DESCRIPTION

Overview

The present invention provides an on-line course support system for providing a course book, along with other related course support features, to students and instructors of a given course, such as English. The students may log into the course book (or course books) portion of the system, thereby enabling the students to view selected portions (pages, chapters) of the course book. In one embodiment, the system provides each student with a user interface that allows the student to complete homework assignments and take tests online. In addition, it can automatically convey the results of the homework and tests to the instructor (e.g., to the instructor's e-mail account, which is not accessible to the student). The system also can include course administration features that allow a teacher or designated administrator, such as a principal, to add or remove users, administer tests, and manage grades. It should be understood that the following discussion provides examples of particular embodiments of the present invention. Accordingly, one skilled in the art will realize that many variations of the embodiments described herein are possible.

System

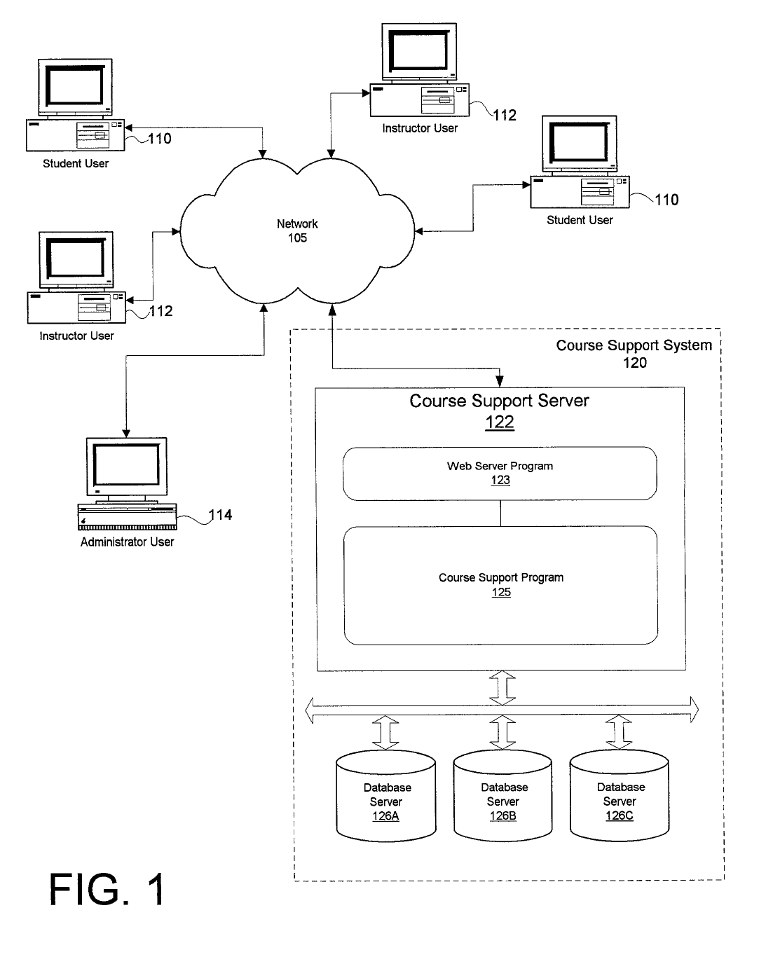

With reference to FIG. 1, one embodiment of the present invention provides an on-line course support system 120 implemented over a network 105 such as the Internet. The course support system 120 is connected to multiple user computers including student users 110, instructor users 112, and administrator users 114 through a network 105. The course support system 120 generally includes one or more course support servers 122 operatively connected to one or more database servers 126. In one embodiment, the course support server 122 is a web-based server for facilitating an interactive, on-line course book that includes course book content (text, illustrations, etc.) and various course support tools such as homework submission tools, automatic test-taking tools, and embedded web links to monitored sites with related, supplemental information.

The course support server 122 includes a web server (internet enabling) program 123 and a course support program 125 operably linked to the web server program 123. The web server program 123 enables the course support server 122 to function as a web server, thereby providing users with web access to the course support program 125. A web server program 123 may be implemented with any suitable internet enabling software such as Apache, Microsoft IIS, and Netscape Enterprise Server. It should be recognized, however, that depending upon the particular network 105 being implemented, any suitable server program can be utilized.

The course support program 125, in cooperation with the one or more database servers 126, facilitates one or more on-line course books, in addition to various course administration tools. Course book content generated by the course support program 125 is typically delivered to users in electronic reader formatted files, which may include combinations of text, scripts, web links, graphics, video, and audio portions. An electronic reader format includes any format that can define (or store) text book content (substantially as it appears in the text book) for consistent appearance between multiple users. Electronic reader files typically have security features such as encryption, encrypted passwords and lock-out utilities and are amenable to compression—both for printing and network transmission. Examples of electronic reader formats include but are not limited to Adobe's Portable Document Format (“PDF”) and Microsoft's MS Reader format.

In one embodiment, the on-line course books are made available to users in addition to corresponding traditional printed versions of the same book. In this way, a student can use either the printed or on-line version of the course book. Normally, the traditional printed versions are in a publishing format such as Quark Express. In such cases, the on-line course book files can easily be generated by converting the publishing format file(s) to one or more suitable electronic reader format files.

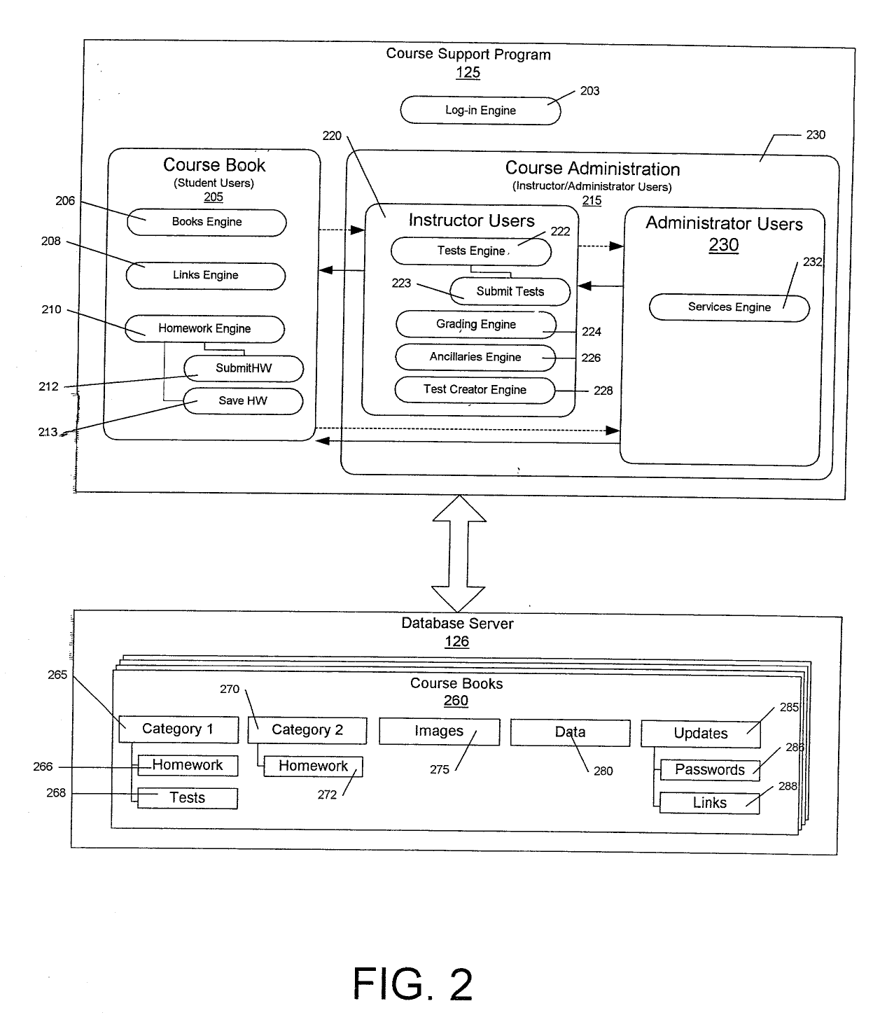

Any suitable programming scheme may be used for implementing the course support program 125. For example, as will be addressed in greater detail below with reference to FIG. 2, it may be implemented with a plurality of common gateway interface (“CGI”) engines (e.g., with Perl scripts) that are invoked by each other and/or by requests from users. Other suitable schemes could include but are not limited to Java servlets, Active Server Pages (ASPs) with plug-ins, and components.

The database servers 126 (126A, 126B, and 126C) are conventional database servers for storing and providing to the course support servers 122 course book and support tool content in the form of HTML templates, graphic files, and other data. They also include administrative course information for specific students and instructors in specific classes within specific school districts. Thus, in the depicted embodiment, the three database servers 126A, 126B, and 126C are shown. They correspond to three separate servers geographically distributed for more efficiently serving the school districts that are utilizing the course support system 120. For example, a separate database server could be dedicated to each state or school district having schools using the system. Each database server could include redundant general content common to the entire system, along with region specific information pertaining to its specific courses and users. Thus, the database servers 126 are linked to one another for more efficiently updating them with common system information. In one embodiment, MY SQL database software is utilized for implementing the database servers. However, the database servers 126 can be implemented with any suitable database scheme including but not limited to flat-file, hierarchical, relational, and object-oriented databases. Likewise, the database, as well as the course support, servers can be implemented with any suitable combination of one or more computers, including but not limited to mainframes, workstations, or personal computers, running operating systems such as Windows NT, UNIX, LINUX, or any other computer operating system.

Similarly, the web user computers 110, 112, and 114 can be any form of appropriate network (e.g., internet) accessible device, including a computer or internet appliance with appropriately operable software for interacting with course support server 122. In one embodiment, this software includes a web browser (e.g., Netscape Navigator, Internet Explorer) and a cooperating electronic reader format program (e.g., Adobe Acrobat Reader 4.05) for displaying course support pages. For example, when PDF files are used for course book content, and the course support system is provided to users via the Internet, a user computer could include a web browser and Adobe Acrobat Reader program. The Adobe Acrobat Reader program serves as a plug-in to the browser for opening PDF files that are transmitted to the user.

Course Support Program

FIG. 2 shows a more detailed block diagram of an embodiment of the course support program 125 coupled to a database server 126. The course support program 125 generally includes a log-in engine 203, course book section 205 with course book engines 206-213, and a course administration section 215 with instructor/administrator engines 222-232. The login engine 203 is used for logging users onto the course support server 122. It validates authorized users and returns back to them an appropriate entry page based on their status (i.e., as a student, instructor, or administrator). The depicted course book section 205 includes course support engines primarily responsible for providing course book content and course book tools to student users. These course support engines include a book engine 206, a links engine 208, a homework engine 210 with an associated submit homework engine 212, and a save homework engine 213. The books engine 206 provides course book content to users in response to user requests for the same. The links engine 208, homework engine 210, and save homework engine 213 provide to users course support tools in connection with the provided course book content. In response to a user selecting a link within a displayed course book page, the links engine 208 provides to the user web (or other network) link information for “linking” the user to a web site (or other network site) related to the content within the displayed course book page. The homework engine 210, along with its associated submit homework engine 212 and save homework engine 213, provides to the user a convenient tool for working on, saving, completing, and submitting homework exercises arising out of the course book.

The depicted course administration section 215 generally includes course support engines that provide to users administrative tools for administering the course books, the courses, and the course support system 120 itself. The course administration section 215 is organized into two separate areas: an instructor-oriented user area 220 and an administrator-oriented user area 230. The instructor area 220 includes a test engine 222 with a submit-tests engine 223, a grading engine 224, an ancillaries engine 226, and a test creator engine 228. The administrator area 230 includes a services engine 232. The test engine 222, along with its associated submit-test engine 223, facilitates the automatic testing of student users from both within and outside of a course book. The grading engine 224 processes and organizes student homework and test grades and also can be used to automatically grade tests and homework assignments. The ancillaries engine 226 provides various resources such as work sheets, course-related materials, and other handouts to the instructors. The test creator engine 228 allows an instructor to modify an old or create a new test. These engines are depicted in the instructor user section 220 because they are primarily controlled and used by instructor users. Finally, the services engine 232 performs administrative services such as adding/removing users and modifying course support system parameters.

In the depicted diagram, the course support engines are organized based on user access, as well as on their functionality (course book, administrative). However, these sections are not rigid and do not necessarily correspond to functional separations between the various engines. Instead, They are used to more conveniently present the operations and interactions of the engines. The student users generally have access to and primarily use the course support engines within the course book section 205. Likewise, instructor users have access to and primarily use the course support engines within the instructor user area 220. The administrator users have access to and primarily use the course support engines within the administrator users area 230. The depicted arrows indicate relative access that the various users have to course support engines outside of their section (or area). The solid arrows indicate complete access, while the dashed arrows indicate partial (or limited) access. Thus, in the depicted drawing, student users would have partial access to the course support engines within both the instructor user and administrator user areas; instructor users would have complete access to course support engines within the course book section 205 and partial access to the course support engines (services engine) within the administrator users section 230; and administrator users would have complete access to all of the course support engines in both the course book section 205 and course administration sections 215 (i.e., they have access to all of the depicted course support engines).

For example, the course book section engines (and thus the student users) could have access to the test engine 222 but not the grading engine 224, which could be reserved for instructor and administrator users. Student users could have partial access, in effect, to the test engine 222, the access to which would be controlled by instructor users. Likewise, instructor users could have complete access to the course book (e.g., to its content, homework exercises, web links) but could have only limited access to administrative service engine functions that pertain to their particular associated students or classes. Administrator users could also have complete access to all course book content and support tools, and in addition, they could have the ability to revise and update all user records within their group (e.g., school district). Special administrator users (such as course support system staff) could have the additional ability to revise and update the course support engines themselves and database server content.

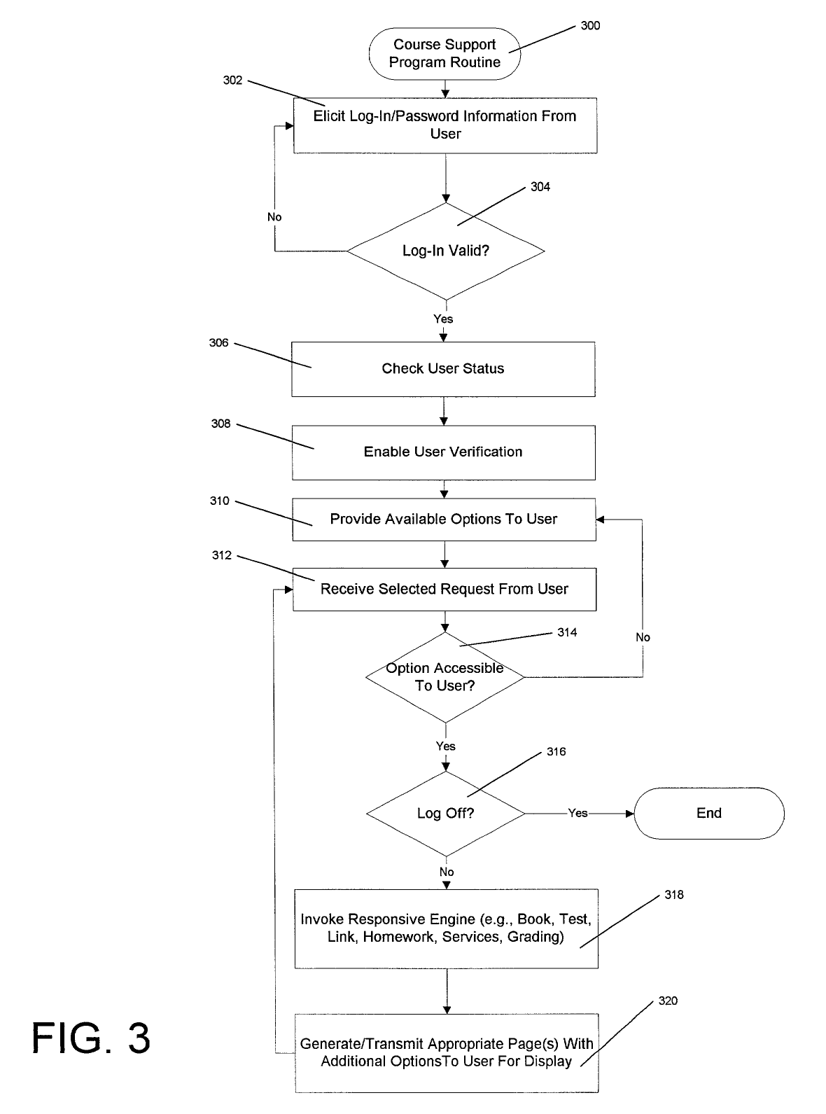

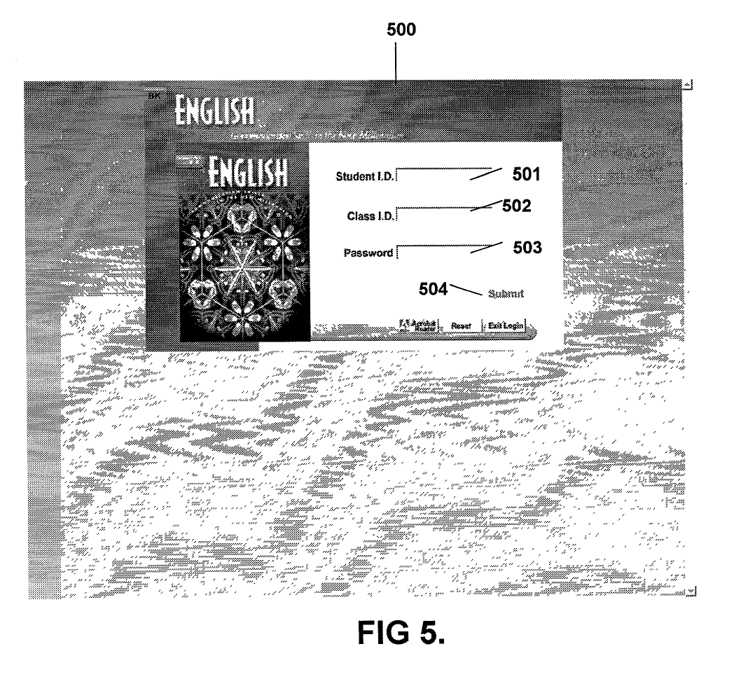

FIG. 3 shows one embodiment of a routine 300 for implementing a course support program 125. As this routine is being presented, various Figures from an example, which will be presented below in connection with FIGS. 5-28, will be referenced to assist the reader.

Initially, at 302, the routine elicits log-in (e.g., username and password) information from a user who has entered the course support system website. This corresponds to the log-in engine 203 being invoked. An example of the login screen 500 is shown in FIG. 5. Next, at 304, the routine determines whether the log-in is valid. If it is not valid, the routine returns the user to step 302, and again elicits from the user a valid username and password. If, at 304, it is determined that the log-in is valid then the routine proceeds to step 306, where it checks the user's status. This involves determining the type of user and whether or not any restriction or unique options have been associated with the particular user.

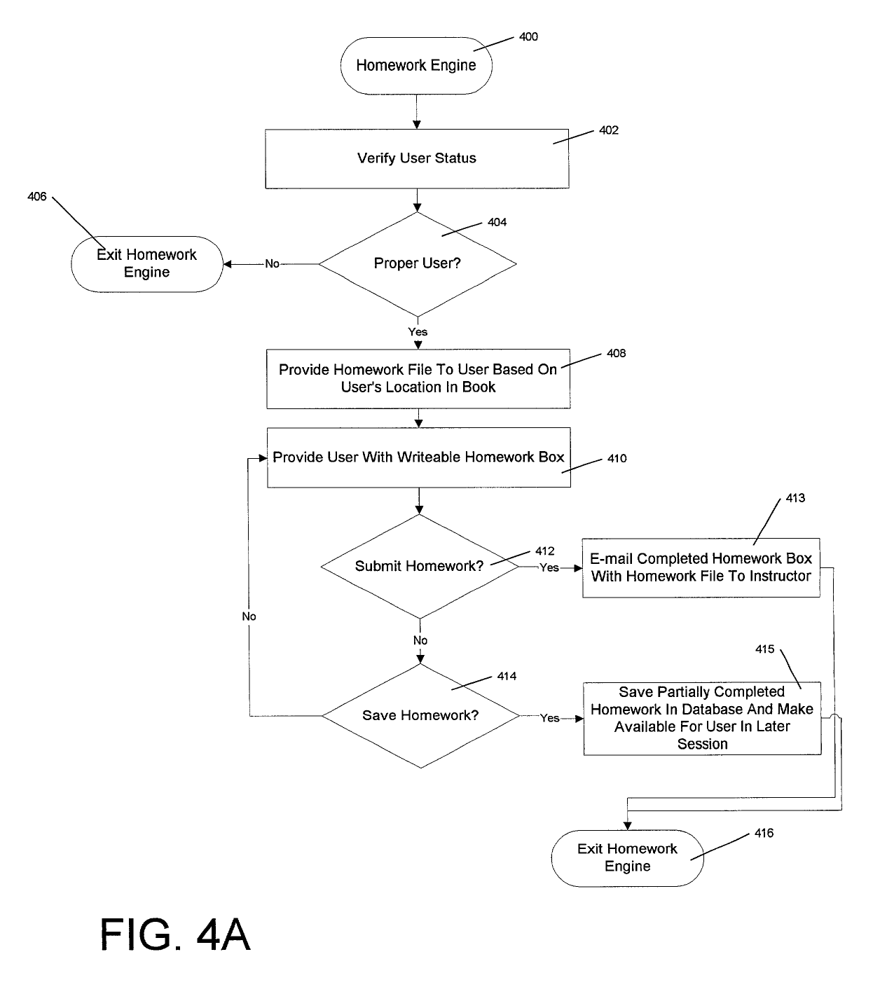

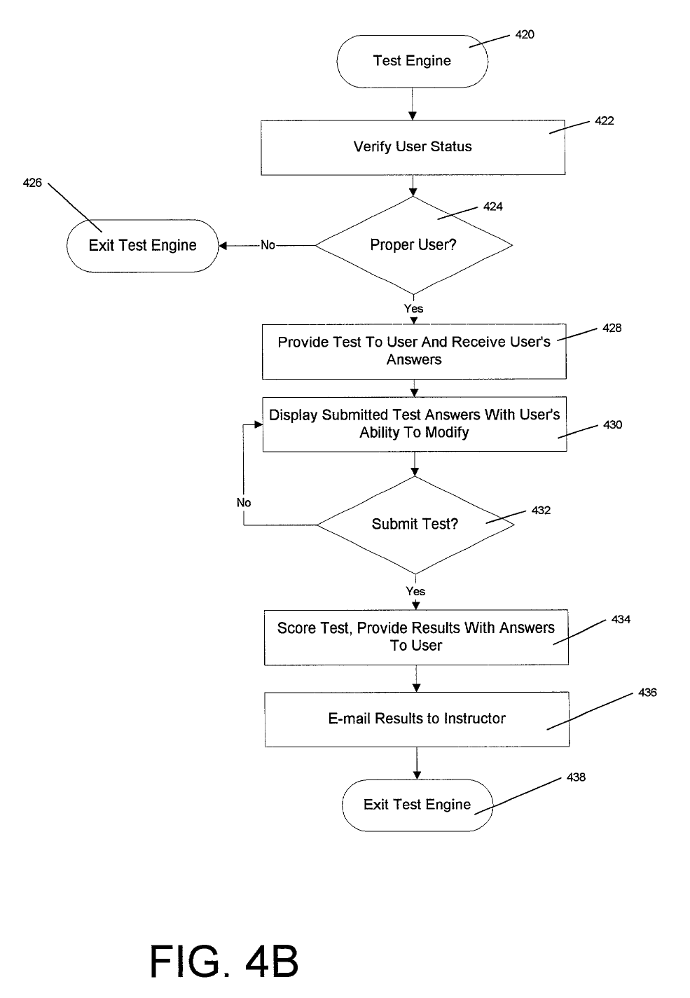

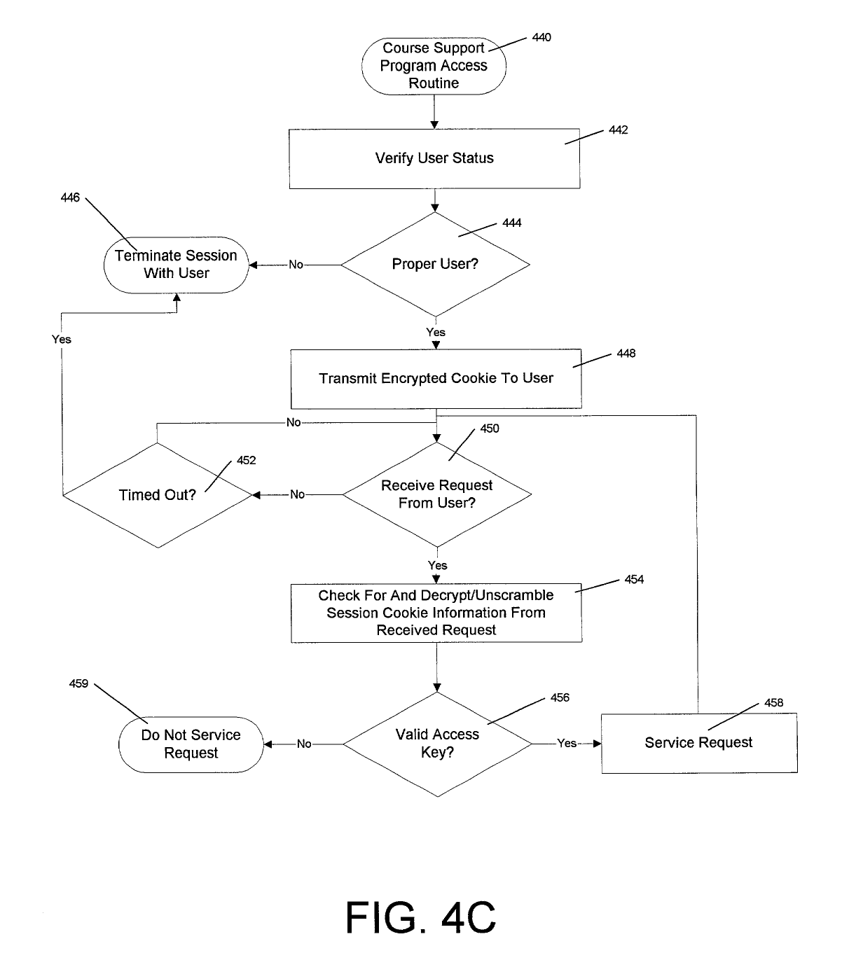

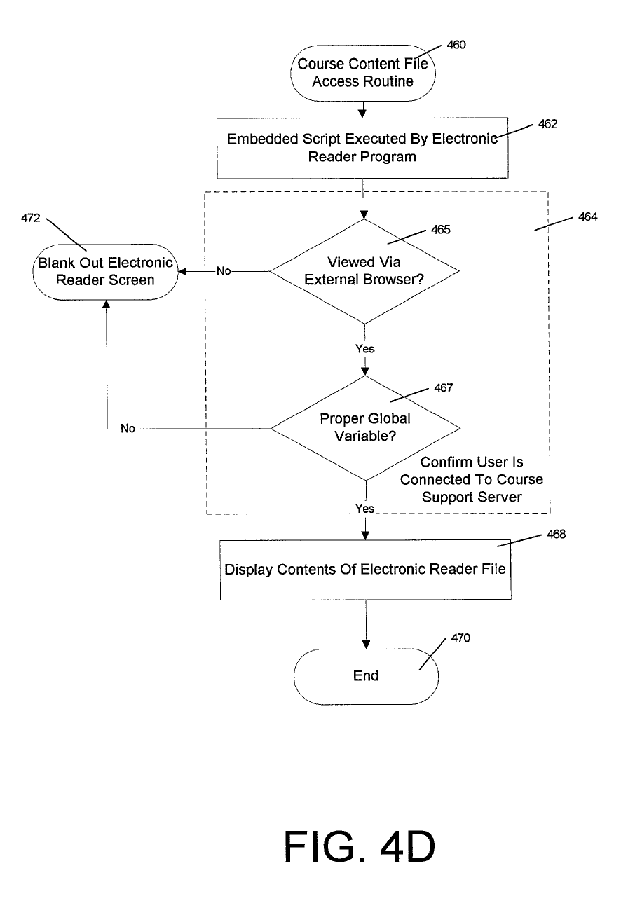

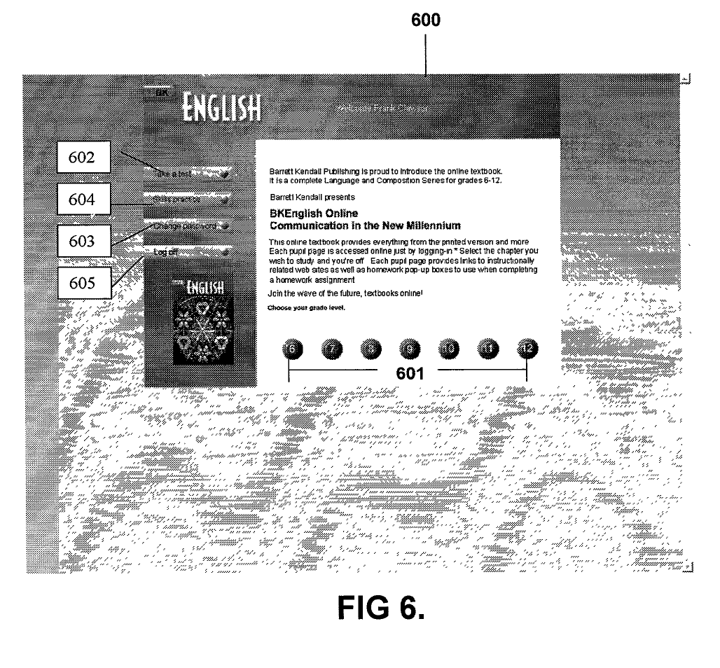

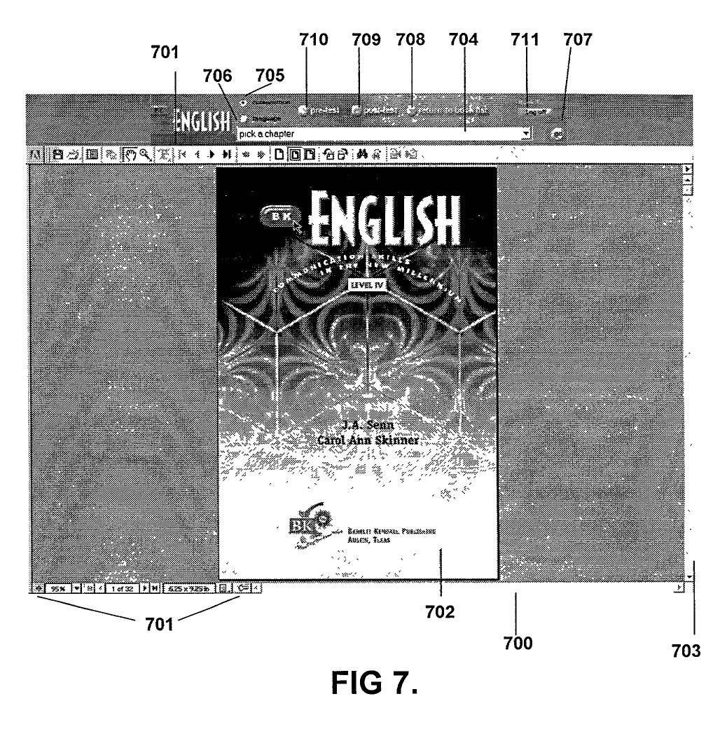

At step 308, the routine enables a user verification procedure, if appropriate. This corresponds to enabling security features, which may be utilized to ensure that only authorized users are viewing course book content in a course support server session. An example of such a security feature is described in greater detail below with respect to FIGS. 4C. Next, at step 310, the system, through a web page, provides to the user course support options, which may or may not be available to the user. At step 312, the course support server receives a selected request from the user in response to the user's selection of a previously presented option. At step 314, the system determines whether the selected option is in fact accessible to the user. If it is not (e.g., user has insufficient priority), then the routine returns to step 310 to provide the user with the course support options once again. From here the routine proceeds as previously described, through step 314. For instance, from the screen 600 shown in FIG. 6, the user may select the version of the online text book that corresponds to the student's grade level by clicking on the numbered button 601 that corresponds to the user's grade level. The system may be configured such that a student user only has access to the version of the online text book that corresponds to his grade level. Thus, a student in twelfth grade would only have access to the twelfth grade version of the book. If the student is in grade 12, and clicks on the button 601 marked “12” in FIG. 6, the system would verify that the student has access to this course support option. The books engine would be invoked, and a page from the grade 12 version of the book would then appear, as shown in FIG. 7. If the student instead clicked on the button 601 marked “7,” the system would determine that the user does not have access to this option. Because the student is not in seventh grade, he is not able to access the seventh grade version of the book. The screen 500 shown in FIG. 5 would remain on the student's computer screen.

If a log-off request is selected, then the routine logs the user off and terminates the session. Conversely, if the selected option is not a log-off request, then the routine proceeds to step 318.

At step 318, the course support program, based on the requested option, invokes an appropriate course support engine for performing the selected option. For a student or instructor user, the book engine 206 (or test engine 222) could initially be invoked for providing the student or instructor with, e.g., a table of contents, course-book selection choices, or test options. Alternatively, the services engine 232 might be initially invoked for an administrator user. Accordingly, at step 320, the executing engine generates and transmits to the user an appropriate web page(s) (which could and usually will include responsive course book content, course support tools, or administrative support tools), along with additional selection options for the user. From here, the routine proceeds back to step 312, where it receives another selected option from the page previously presented to the user. From here, the routine proceeds as previously described. At step 318, an appropriate engine is then invoked to provide a web page that is responsive to the user's option selection. The routine continues in this option selection progression loop until the user eventually selects a log-off option, which causes the routine to terminate from step 316.

Course Support Engines

The course support engines will now be addressed in greater detail. In describing the various course support engines, for ease of understanding, the reader may be directed to one or more figures from FIGS. 5-28, which are used in connection with the example presented later in this description.

In one embodiment, the course support engines are implemented with PERL 5.0 CGI scripts, which run across most major web server platforms. However, as previously mentioned, any suitable programming scheme for generating and providing to users the course book content, course support tools, and administrative tools of the present invention will suffice.

The books engine 206 responds and sends to users course book pages typically in the form of electronic reader files (e.g., PDF), which may be transmitted as web pages sent to the user. Responsive to course book content requests, it has been found effective to deliver to users files corresponding to one or several requested course book pages rather than to a whole book. That is, with some users having relatively slow computers and/or slow connections to the course support server 122, it is more effective to transmit the course book to the user one page at a time in response to a particular page(s) request, rather than sending the entire course book in a single file.

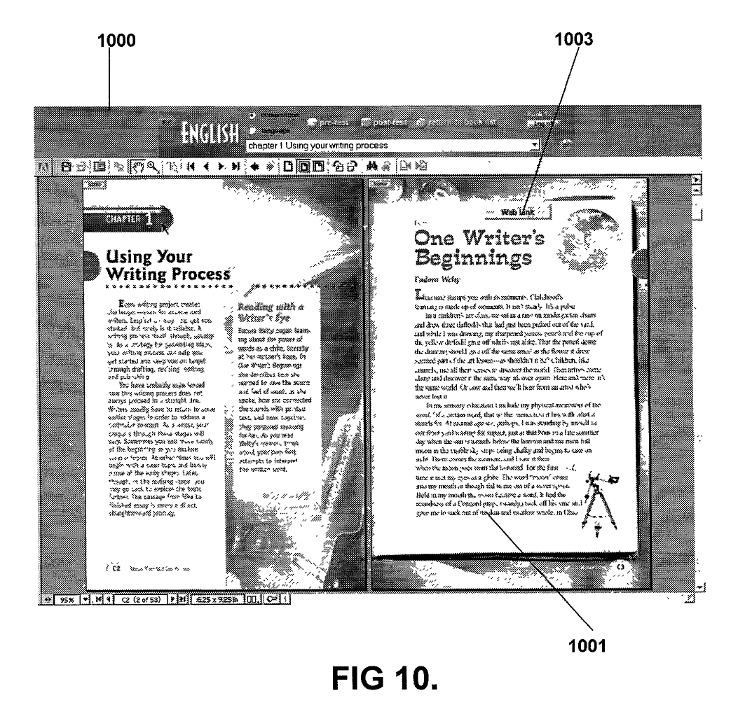

An example of a course book page that might be seen by the user is shown in FIG. 10. In connection with the electronic reader file program, browser and web file commands sent to the user, it responds to user interface buttons (e.g., forward, back, page #) for conveniently providing a user with desired course book pages. For example, as shown in FIG. 7, traditional Adobe Acrobat toolbars 701 may be used to navigate 10 between pages. The books engine 206 may be invoked by any of the users as well as by other engines within the system. In addition, it may invoke other engines in responding to content requests from a user.

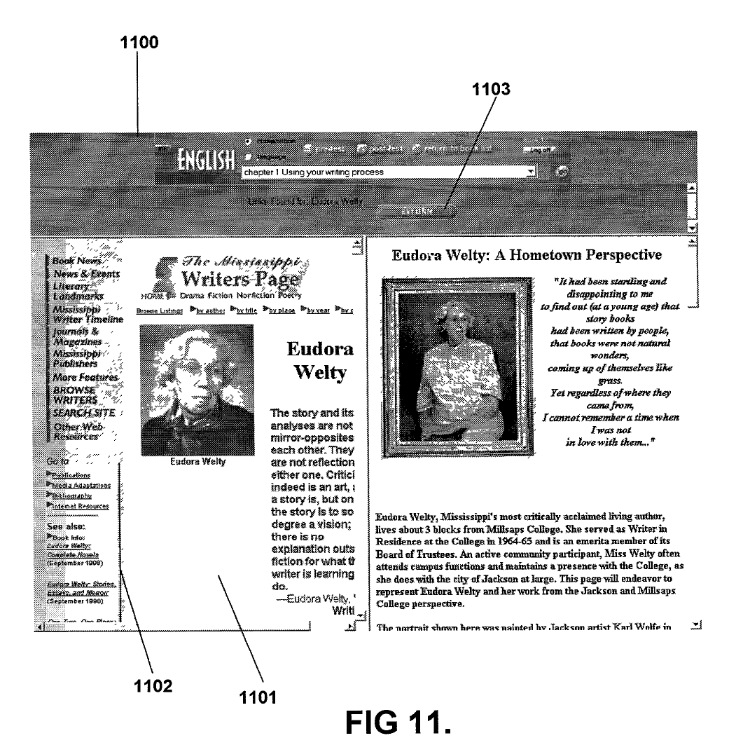

The links engine 208 serves as an interface between links embedded in the course book pages and the actual link address information (e.g., URL) for “linking” the user to a site related to the surrounding course book content. Links can be links for any network site such as for web sites or other network sites on, e.g., an isolated wide area network (“WAN”). When a user selects a link, a request is transmitted to the course support server that causes the links engine to be invoked. After verifying the user, the links engine 208 retrieves the actual link site address (e.g., URL) from the database server 126 and submits with it an HTTP request on behalf of the user. The user then receives the web pages associated with the site. In one embodiment, the links engine 208 retrieves links only from the links database 288, and in this way administrators for the course support system 120 can control the web sites that are available to the users. In addition, the content (electronic reader) files need not be updated with corrected link addresses. Instead, only the addresses in the database need to be modified when site addresses change or are to be replaced. FIG. 10 shows an example of links incorporated in a content page. If the student selects the web link button 1003, he is taken to a web page that is associated with that link. The web page may be displayed in the manner shown in FIG. 11.

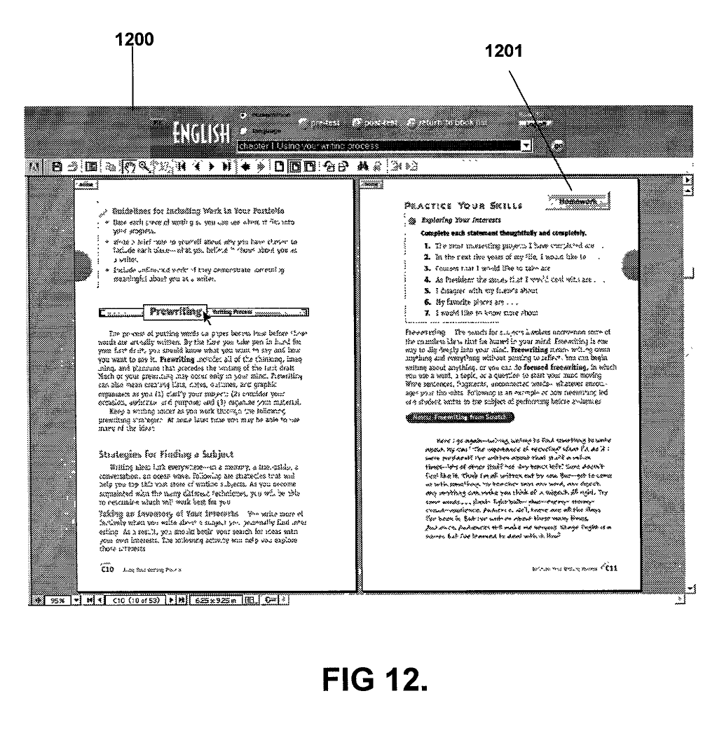

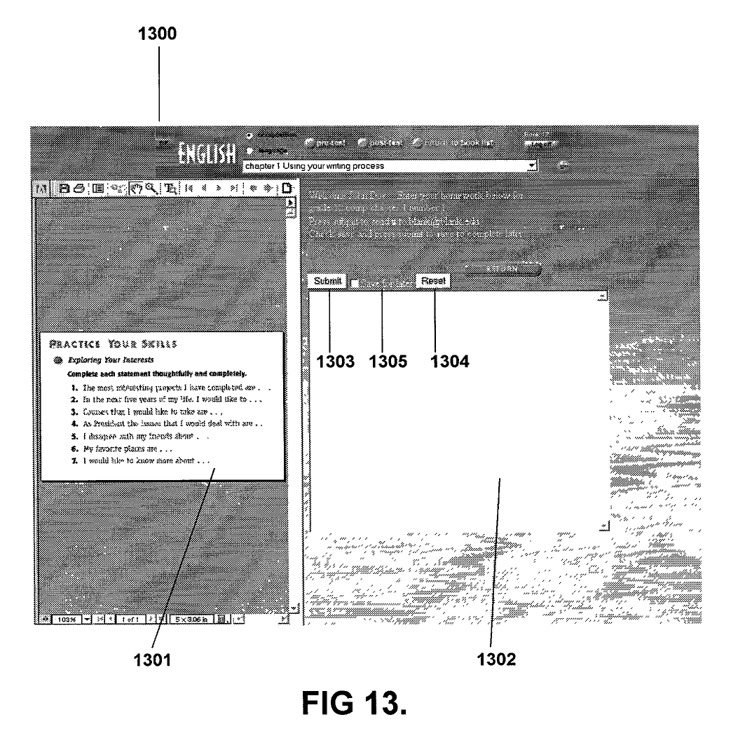

The homework engine 210 implements the main homework tool program. It is invoked by a user through the selection of a “homework” option in the course support system user interface or embedded within a displayed course book page. Homework buttons 1201 may be embedded in various pages of the course book, as shown in screen 1200 of FIG. 12. When the user selects the homework option, the homework engine presents to the user a homework assignment (exercises) graphics file, along with a simultaneously displayed writable homework box form. An example of a homework screen is shown in FIG. 13. The user can complete the homework by typing responsive answers into the homework box 1302 and selecting a “submit” button 1303 to invoke the submit homework engine 212. The submit homework engine 212 causes the completed homework box, along with an attached copy of the homework assignment, to be automatically transmitted via email to the user's instructor. In one embodiment, the submit homework engine 212 accesses the services engine 232 in order to acquire the appropriate email address for the student's instructor from the database server 126. In this way, the completed homework is conveniently delivered to the instructor without the students having direct access to the instructor's e-mail address. If a student begins a homework project but does not finish it within a given session, she can “save” it by selecting a save homework option 1305, which causes the save homework engine 213 to be invoked. When invoked, this engine stores the partially completed homework in database 126 and makes it available to the user for a later time.

With reference to FIG. 4A, a routine for implementing a homework engine will now be described. Initially, the routine verifies the user's status at step 402 (e.g., with the user verification technique addressed above and described below in connection with FIG. 4C). Next, the routine determines whether the user is a proper user for implementing the homework routine at step 404. If the user is not a proper user, then the homework engine is exited at step 406. Conversely, if the user is a proper user, then the routine proceeds to step 408, where a homework file is presented to the user based on the user's location within the book (i.e., current web page being displayed). Next, at step 410, the routine provides the user with a writeable homework box 1302 in connection with the displayed homework questions 1301, as shown in FIG. 13.. Next, at step 412, the routine determines whether the homework box has been submitted by the user. If it has not yet been submitted, this implies that the homework box is still being displayed to the user in connection with the user's completion of the homework assignment. If this is the case, the routine proceeds to step 414. On the other hand, if the homework box has been submitted (i.e., the user selected a submit homework option), then at step 413, the completed homework box with the homework file is sent (e.g., via email) to the instructor. If the routine had proceeded to step 414, it would check to see if the user selected a save homework option. If so, the save homework engine 213 is invoked to save the user's homework and make it available for a later session. If the user has not initiated a save homework option, then the routine goes back to step 410 and continues to provide the user with the homework box for receiving homework data from the user. It should be pointed out that the flow diagram here (as well as in other diagrams in this disclosure) is used to generally convey what is being performed by the engine. However, the invention is not limited to the specific logic implied in the diagrams. For example, in FIG. 4a, it is implied that the Homework engine implements a loop that periodically checks to see if the user has initiated a submit homework or save homework option. While it could perform the routine in this manner, it could also perform the routine in other ways such as by having the submit or save homework engines asynchronously invoked by the user instead of from the Homework engine.

The test engine 222 is responsible for generating tests (pre-tests, post-tests, and controlled tests) that will be presented to student users. The test engine is represented in the instructor user section 220, because the instructor user has control over the content and accessibility of tests with respect to students within a particular instructor's course. Therefore, student users, who are accessing the system through the course book section 205, have limited access to the test engine 222, as defined by their instructor.

The test engine 222 presents to a user one or more questions or exercises relating to a particular section within the course book. The user completes the test by appropriately responding to each of the questions, and submitting the test through invocation of the submit test engine 223. Any suitable scheme can be used for implementing the tests. For example, in one embodiment a pull-down menu is incorporated within each question. The pull-down menu has one or more options that can be easily selected by a user. Once the user has selected an answer within each pull-down menu, then the test engine allows the user to submit the test through invocation of the submit-test engine 223. The submitted test answers are graded and presented back to the instructor via its email account.

If enabled by the instructor (e.g., if the test is classified as a “pretest exercise”) the score may also be presented back to the student user immediately after the test answers are submitted. In this way, a user can conveniently determine where he/she did well and where he/she needs additional work.

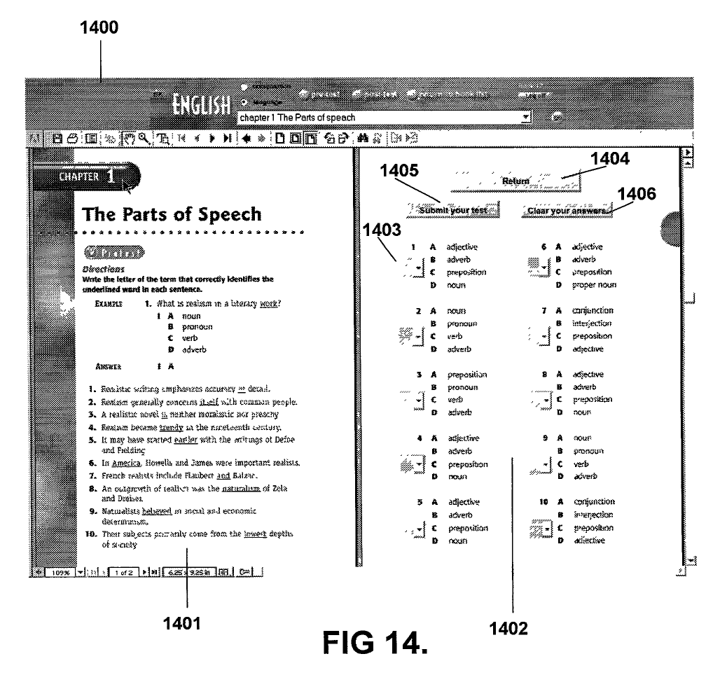

For example, once the student has successfully accessed a particular chapter of the course book, he may opt to take a pre-test or a post-test by selecting the pre-test button 710 or post-test button 709 located on the screen, as shown in FIG. 7. For instance, if the student selected the pre-test button 710, a screen similar to that shown in FIG. 14 would appear. The student may enter his answers using the provided answer boxes 1403. Once the student has finished entering his answers, she may submit the test by clicking on the submit test button 1405. A student may take a post-test in the same manner.

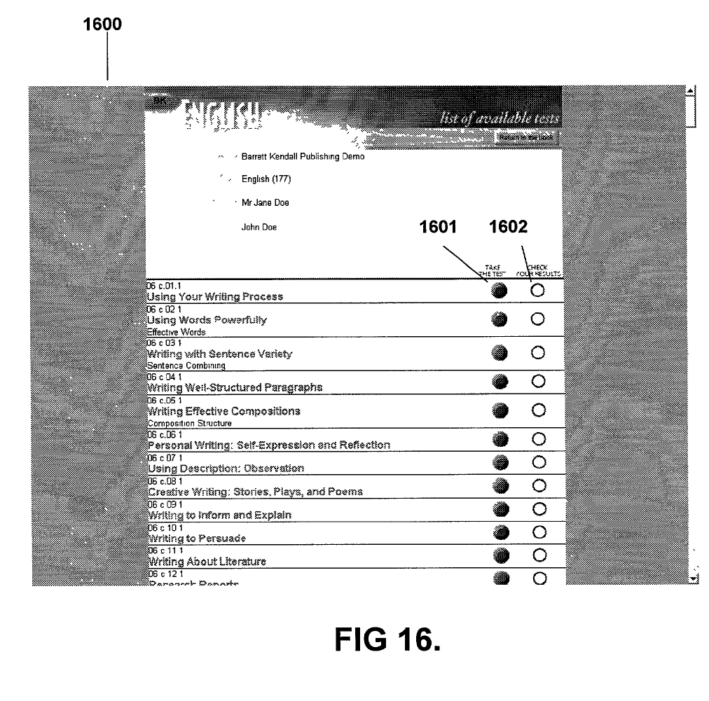

A student may also take various controlled tests that have been enabled by the teacher. From the screen 600 shown in FIG. 6, the student may select the take a test button 602. A list of tests, as shown in FIG. 16, will then appear. A student may then opt to take a particular test if that test has been enabled by the teacher.

With reference to FIG. 4B, one embodiment of a particular routine for implementing a test engine at 420 will now be described. Initially, the routine verifies the user's status at step 422. Next, at step 424 the routine confirms that the user is a proper user for executing the particular test engine routine. At step 428, the routine provides the requested test to the user and receives the user's answers if it was determined at step 424 that the user has access to the test. On the other hand, if the user does not have access to take the test (e.g., the instructor has locked out the test at that time) then the test session is terminated at step 426. At step 430, the routine displays the submitted test answers and gives the user the ability to modify her answers. Next at step 432 the routine determines whether the user submitted the test. If the user selected a “submit request,” then the routine scores the test and provides the user's results along with the correct answers to the user at step 434. At step 436, it also emails the results of the test, with the questions, to the instructor. From here, the test routine is exited at step 438.

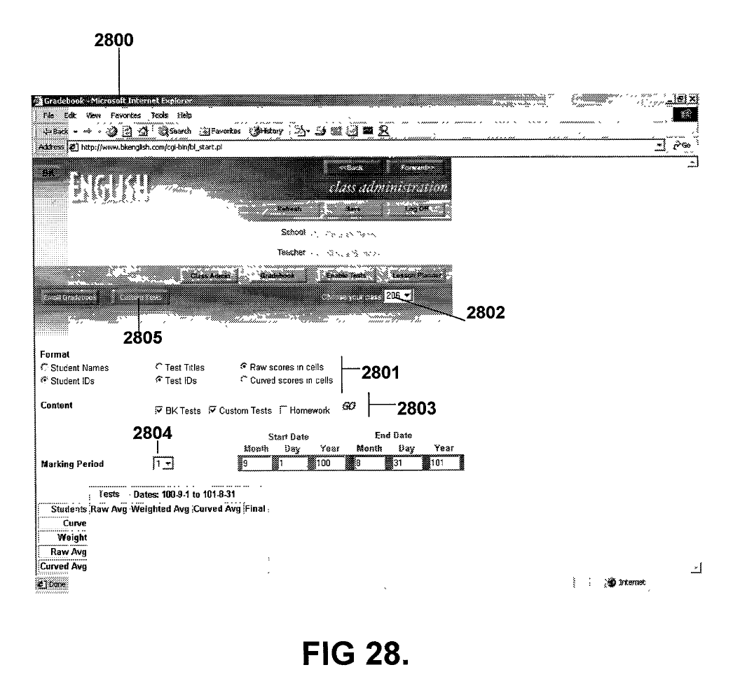

The grading engine 224 implements a program for not only scoring test results but also accumulating and processing any or all of the various test scores for each of the students within a course. It enables the instructors to basically grade, check grades, enter their own grades, average scores, download the grades to spreadsheets (e.g., Excel format), manage the classroom, change passwords through the services engine 232, and perform various other tasks. For example, as shown by the screen 2800 in FIG. 28, a teacher may view the grades received on a particular test by each student in her class. A teacher may also view a summary for each student that includes information such as the student's grade average and the student's highest test score and lowest test score.

The ancillaries engine 226 may be invoked by an instructor to present the instructor with various teaching aids and other materials. For example, down-loadable handouts and web links associated with additional information related to the course book could be provided to the instructor in a web page through invocation of this engine. With the engine restricted to only links and materials stored on the database server 126, the system could control and more effectively maintain the quality of such information.

The test creator engine 228 allows the instructor to create new or simply modify existing tests on the system. In one embodiment, a separate status check is performed when this engine is invoked to ensure that the particular instructor is qualified to create such tests. In this embodiment, numerous tests can be made available to instructors on the system. In this way, subscribers to the system could have access not only to resources provided by the system administrator, but also, to resources (e.g., additional tests) provided by other users in the system.

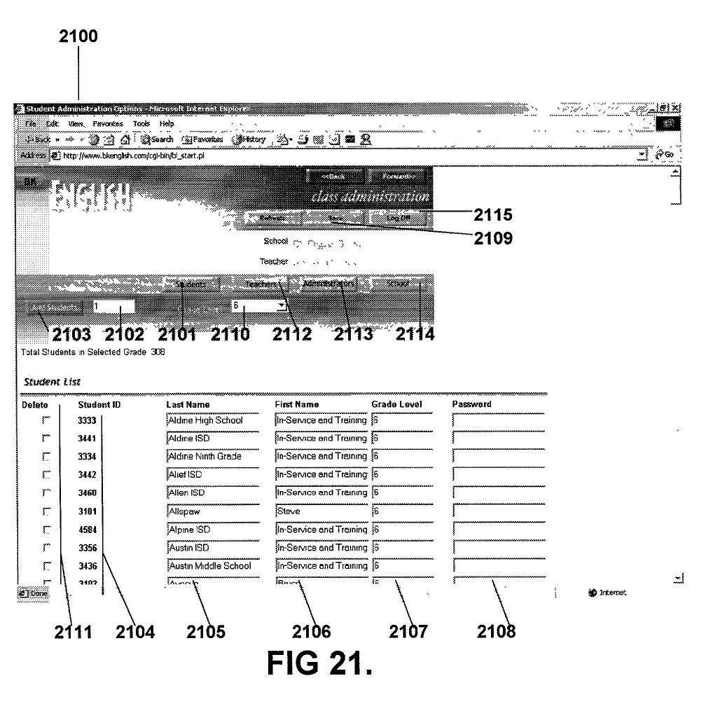

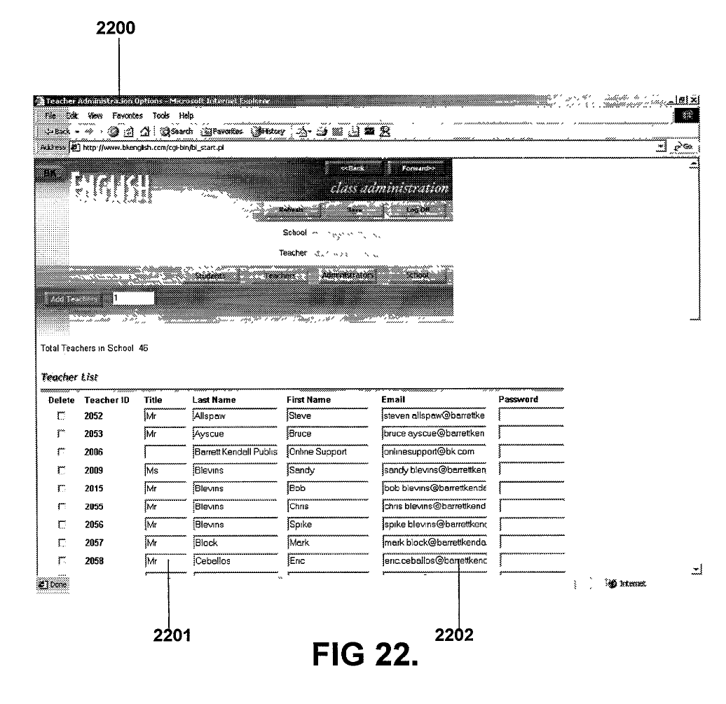

The services engine 232 performs all of the various administrative tasks for updating the course support system. Typically, only administrator users have complete access to the services engine 232. The services engine allows administrator users to add/remove student users (FIG. 21), add/remove instructor users (FIG. 22), to modify course definitions, to modify content within the database server 126, and to perform a plethora of other administrative jobs.

Security

The present invention contemplates various security techniques, which may be used alone or in combination with one another, for inhibiting a user's ability to copy, modify, and/or display without authorization. In one technique, the course support program 125 includes a course support engines access routine that validates a user before it can invoke a course support engine. This ensures that course support engines are only invoked by authorized users who are actually connected to the course support server 122.

FIG. 4C shows one embodiment of a routine for implementing this validation technique. When the user initially logs onto the server, its status is verified at step 442. This involves matching the user's password and user identification against valid identifiers in database server 126. If it is determined that the user is not a proper user at step 444, then the user is denied access to the system at step 446. On the other hand, if the user is proper, them the server 122 transmits to it an encrypted access key, e.g., in a session cookie, which is provided to the user's executing browser. This information serves as a key for invoking the various course support engines available to the user. For example, the information key could include user validation information, routing information (e.g., for one engine to invoke another engine), and user identifiers. In one embodiment, the information is sent in a session cookie and is encrypted using Unix Crypt. When a user makes a request to invoke a course support engine (e.g., when a course book page is requested or a link is selected), the server checks the user's cookie for the encrypted key and if found, decrypts it at step 454. It compares the decrypted information against corresponding expected information for that user at step 456. If the information matches, the user's request is serviced (i.e., the appropriate course support program engine, e.g., books, is invoked) at step 458. On the other hand, if the decrypted information is not correct, the user's request is not serviced at step 459.

In one embodiment, the routine has a time out feature that makes the information key valid only for a specified amount of time (e.g., 20 minutes). If it has been too long since the user received from the server a valid access key, then the server will determine at step 456 that the access key is invalid, and the user's request will not be serviced. Therefore, the server periodically transmits to the user updated access keys while the user is properly logged onto the system. Along these lines, at step 452, the routine will terminate the session if it does not receive a request from a user within a predefined period of time.

With reference to FIG. 4D, in another security measure, each course book content file (e.g., PDF file sent to user) is embedded with a client-side security script that allows the file to only be opened if the user is properly logged onto the course support server. When the user opens the file, the electronic reader program (e.g., Adobe Acrobat Reader) executes the script at step 462. At step 464, the executing script confirms that the user is connected to the course support server. In the depicted embodiment, this involves (1) confirming that the file is being viewed through an external browser at step 465, and (2) at step 467, confirming that proper variable(s) have been set by the server. In one embodiment, when PDF files are used, the script checks to see if the “External” variable has been set, which indicates that the file is being viewed through an external browser. In one embodiment, the variable to be set corresponds to an encrypted time/date value that is set by the server when the user properly logs onto the system. If both conditions are satisfied, then the content is displayed at step 468. Conversely, if either condition is not satisfied, then the electronic reader program prevents the content from being displayed at step 472. In this way, a user cannot display course book content without being logged in to the course support server 122. That is, even if a user is able to save course support web pages (e.g., electronic reader files such as PDF files with course book content) on its computer, it will not be able to access (e.g., display, copy, or modify) them.

Depending upon the particular type of utilized web pages and electronic reader files, other security schemes may be implemented as well. For example, when conventional HTML web page files and PDF course book content files are used, the HTML part of the web page could include a command(s) (e.g., Meta tag in HTTP header of HTTP response from course support server) for disabling the browser's web navigation functionality such as by removing the tool and menu bars. With PDF files for displaying course book content, “copying” and other similar functionality can also be disabled.

Database Server

With reference once again to FIG. 2, the database server 126 comprises a plurality of course book folders 260, which each include various directories and subdirectories of data, graphics, and other files used by the course support engines. There are a plurality of course book folders 260—with each folder corresponding to a different course book (e.g., different grade, different subject). Each course book folder 260 includes one or more category folders 265, 270, an images folder 275, a data folder 280, and an updates folder 285. The category folders 265, 270 correspond to different categories of information within a particular course book. For example, in one embodiment with the course book 260 being an English course book, the first category 265 is Language, and the second category 270 is Composition. A student may navigate between the two categories by selecting the composition button 705 or the language button 706 as shown in FIG. 7.

In this embodiment, the Language category has a homework folder 266, and a tests folder 268, while the composition folder has only a homework folder 272. The categories were defined in this way (for the English course book example) because automated test engine tests, in this embodiment, are used for language but not composition sections. The homework folder 266 contains all pages pulled from the book for homework from the language section. Likewise, the tests folder 268 contains all tests from the book associated with the language section. The homework folder 272 in the Category 2 folder contains all pages pulled from the book for homework from the Composition section.

The images folder 275 contains course book content (e.g., in PDF files) used by the course support engines for a particular course book 260. In one embodiment, the course book pages are stored in an appropriate electronic reader format (e.g., PDF) and compressed for storage within the database server 126. Specific course book pages, which are retrieved by the book engine 206 and homework graphics retrieved by the homework engine 210, are stored in the images folder 275. Likewise, the data folder 280 contains all of the HTML templates used by the course support engines for the particular course book. Finally, the updates folder 285 is a secure folder containing the code to access the passwords and web links databases, 286 and 288 respectively.

The passwords database 286 includes all of the passwords and mapped user information for the various users for the particular course book 260, while the links database 288 contains all of the link (e.g., web link) information for the particular course book 260. The database server 126 may also include a folder for storing the course support engine programs used by the course book 260. For example, in one embodiment, each course book folder 260 includes a CGI Bin folder for storing CGI scripts for implementing each of the course support engines used by the course support program 125.

### EXAMPLES

With reference to FIGS. 5 through 28, exemplary course support system screens are presented for an English course book available in multiple grades. Three separate examples—one for each user type—are given. The examples present a progressive series of course support session screens—first for a student user, next for an administrator user, and finally for a teacher (instructor) user.

Logging in as a Student

FIGS. 5 through 19 show screen printouts of one embodiment of the online course support system of the present invention for an English textbook. The figures illustrate some of the screens that a student would see when logging into the system and engaging in a course support session. To log into the system, and thereby obtain access to the content and features of the online course book, one embodiment of the present invention requires that the student first go to a specified URL address using an internet browser. The student may then click on an icon that will make an initial log-in screen appear.

FIG. 5 shows the initial screen log-in screen 500 that a student sees when going to a specified URL address. As FIG. 1 illustrates, the system may be configured such that all features of the internet browser used by the student are hidden once the log-in screen 500 appears. These features may remain hidden until the student logs out of the system. It is advantageous to hide the features of the web browser because it removes potential distractions from the student's view. For instance, if the student is able to easily access the features of the web browser while he is logged into the online course book, the student may be tempted to enter different URL addresses into the web browser to go to various web pages on the internet.

To log into the system and thereby obtain access to the content and features of the online course book, a student needs a student I.D. 501, a class I.D. 502, and a password 503. The student I.D. 501 and password 503 will be unique to each student. The class I.D. 502 may be used to identify the particular grade level, school and class in which the student is enrolled. Once the student has entered this information, he may click on the submit icon 504 to log into the system.

Once a student effectively logs in, a book list screen 600, illustrated in FIG. 6, appears. Several options are available to the student at the book list screen 600. The depicted options include take a test 602, change a password 603, skills practice 604, and log off 605. Clicking on the change a password button 603 allows the student to change his log-in password. Clicking on the log off button 605 will log the student out of the system. The take a test and skills practice options are discussed in more detail below.

As also illustrated in FIG. 6, the book list screen 600 contains grade icons 601 that allow a student to select the version of the course book that corresponds with his grade level. For instance, if the student is in twelfth grade, he would click on the “12” grade icon. A screen displaying the cover of the twelfth grade version of the book would then appear, as shown in FIG. 7. From this screen, the student may scroll through the pages of the table of contents of the book in the manner described below.

In one embodiment of the invention, the student is only able to select the version of the book corresponding to the student's grade level. For instance, a twelfth grader may only be able to select the twelfth grade version of the book. Because the student logs into the system using a class I.D. 502, the system can recognize the student's grade level, and access may accordingly be restricted to the version of the book that corresponds with his grade level.

As previously stated, once a student selects the grade icon 601 corresponding to his grade level, the screen 700 in FIG. 7 appears. Adobe Acrobat tool bars 701 may be located on the screen 700. The features of the Adobe Acrobat toolbars may be used, for example, to navigate between pages of a section of the online text book. Additionally, the system may be customized to disable some of the traditional Adobe Acrobat features. For instance, the cut and paste commands on the Acrobat toolbar may be disabled. It may be desirable to disable some of the commands. As discussed in more detail below, a student may type in homework assignments in designated homework boxes. Disabling the cut and paste commands prevents the student from copying portions of the book and pasting it into the homework box.

A page 702 of the online text book appears in the center of the screen 700. It is possible to scroll between the center pages by using a scroll bar 703 located to the right of the page. Features of the Adobe Acrobat toolbars 701 may also be used to scroll or jump between center pages 702. It will be readily apparent to those skilled in the art how to use the features of the Adobe Acrobat toolbars to navigate through the course book pages.

In another embodiment of the invention, a page may be shown in the center of the screen and thumbnail images of pages of the selected chapter or section of the book may be located to one side of the screen. A student may navigate between pages by using a scroll bar to scroll through the thumbnail images. When a student clicks on a desired thumbnail image, an enlarged image of that page of the book will be displayed in the center of the screen.

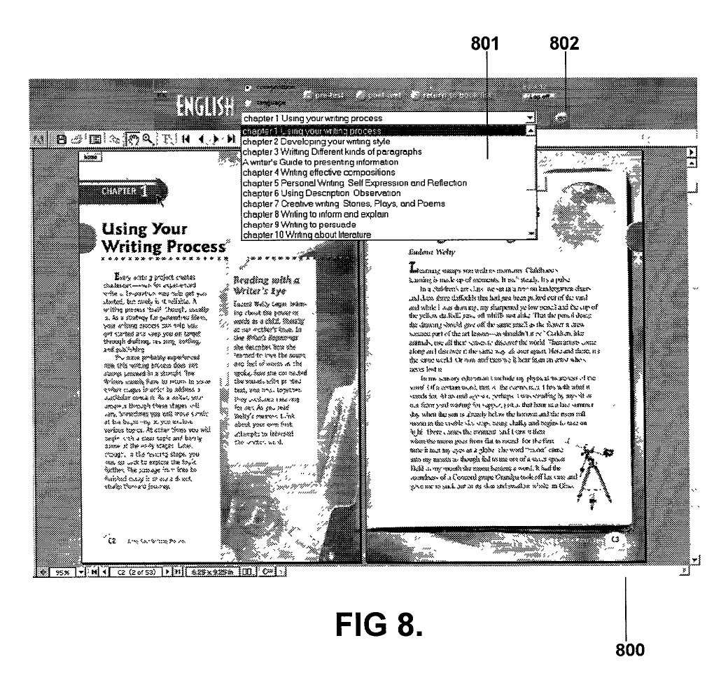

When a student initially accesses the course book by selecting the appropriate grade icon 601 in FIG. 6, he is taken to the table of contents section of the text book, shown in FIG. 7. From this screen 700, the student may scroll through the pages of the table of contents in the manner previously described. The student may jump directly to a particular chapter of the book by using the chapter drop down box 704 and clicking on the go icon 707. Once the student clicks on the chapter drop down box 704, a scroll box 801 containing the various chapters in the book appears, as illustrated in FIG. 8. A student may jump to a particular chapter by clicking on the desired chapter in the scroll box 801, and then clicking on the go icon 802.

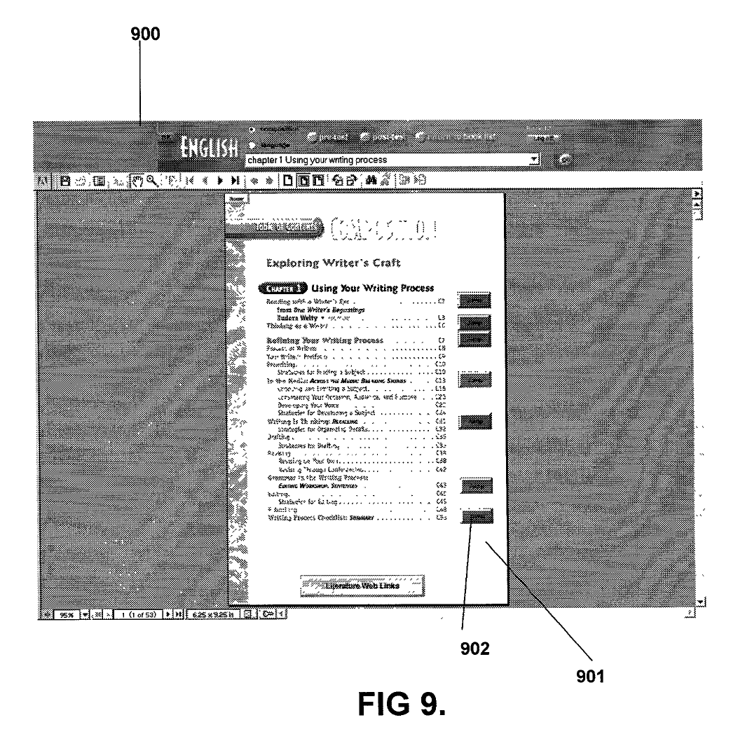

A student may also jump directly to pages within the book by using features found in the table of contents. A representative page 901 of the table of contents is illustrated by the screen 900 shown in FIG. 9. Jump buttons 902 are located next to various page listings in the table of contents. A student may jump to a desired page of the chapter by clicking on a jump button 902 that is next to the desired page.

The pages of the course book of the present invention have many useful features. Returning to the screen 700 shown in FIG. 7, there is shown a composition button 705 and a language button 706. These button correspond to the composition portion of the English course book and the language portion of the course book. Similar buttons may be used for any book that is divided into two or more portions. A student can navigate between the composition portion of the English course book and the language portion of the English course book by clicking on these buttons 705, 706. Each portion of the book may have its own table of contents, page numbers, and chapters.

A student may return to the book list screen 600 by clicking on the return to book list icon 708. The student may log out of the system by clicking on the log off icon 711.

As shown on the page 1001 in the screen 1000 in FIG. 10, pages of the course book may have a web link button 1003. Clicking on the web link button will take a student to a screen containing content from web pages that is related to the subject matter discussed on the page where the web link button 1003 was located. An example of a web page content screen 1100 is shown in FIG. 11. As FIG. 11 demonstrates, a web page 1101 appears on the screen 1100. Although a standard internet browser may be used to retrieve the information, the browser toolbars may be hidden from view thereby giving a screen appearance similar to the one in FIG. 11. A student may navigate through the content of the web page by clicking on links 1102 located on the page 1101. The student may return to the page of the text book from which he linked to the web page by clicking on the return button 1103.

Some pages of the course book may contain a homework button 1201, as shown on the screen 1200 of FIG. 12. When a student clicks on the homework button 1201, a screen containing a homework assignment will appear. One example of such a screen is illustrated by the screen 1300 shown in FIG. 13. In the embodiment shown in FIG. 13, the homework assignment 1301 is located on the left of the screen 1300. The student may type his response to the assignment in the box 1302 located on the right side of the screen 1300. If the student clicks on the reset button 1304, all the text that has been entered by the student is erased. When the student has completed the assignment, he may click the submit button 1303. A screen may then appear confirming that the homework assignment has been electronically sent to the student's teacher. The completed assignment will then be sent electronically to the student's teacher. In addition, a student may choose to complete part of the homework assignment, and then save it without turning it in. The student may return to the saved assignment at a later time, complete it, and then turn it in. This may be accomplished by checking the save for later icon 1305.

In addition to completing homework assignments, a student may also take a pre-test and post-test for many of the chapters in the course book. These tests are useful tools that allow the teacher to evaluate a student's weak and strong points. A student may access the pre-test for a particular chapter by clicking on the pre-test button 710, as illustrated in FIG. 7. If, for example, a student had previously selected chapter 1 of the language portion of the course book, and then clicked on pre-test button 710, the screen 1400 of FIG. 14 would appear.

In the embodiment shown in FIG. 14, the pre-test questions 1401 appear on the left of the screen. There is a second window 1402 on the right side of the screen where the student may enter his answers. When the student clicks on one of the answer boxes 1403, a drop down box appears that lists the possible answer choices. A student clicks on one of the answer choices in the drop down box to select that answer choice. A student may clear all of the answers he has entered by clicking on the clear your answers button 1406 on the page. Student may abandon the test and return to the text book pages by clicking on the return button 1404.

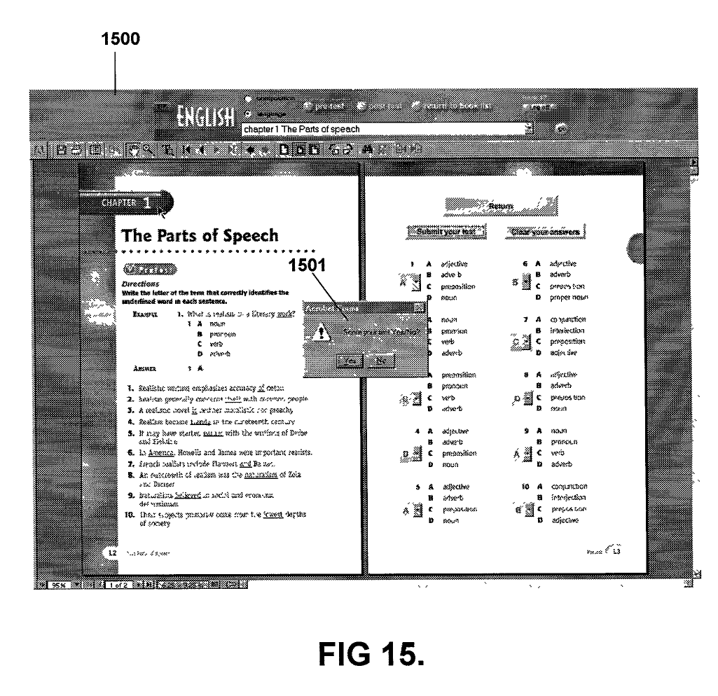

Once a student has finished selecting answers, he may submit the test to the teacher by clicking on the submit your test button 1405. If the student has not answered one of the questions, a screen will appear that indicating that not all questions have been answered. The student may then return to the pre-test and fill in the missing answers. When all of the questions have been answered, and the student clicks on the submit your test icon 1405, the screen 1500 shown in FIG. 15 will appear. If the student is sure that he wishes to submit his test, he may click the yes button in the question box 1501.

Once the pre-test has successfully been submitted, it is scored automatically, and the results are sent to the student's teacher electronically. In one embodiment of the invention, when the student click on the submit your test button, a screen appears that contains the student's score on the pre-test, as well as other information, which may include the questions and correct answers to the pre-test. Post-tests may be taken in the same manner by clicking on the post-test button 709 instead of the pre-test button 710.

As previously stated, a student may take a test by clicking on the take a test button 602 located book list screen 600 illustrated in FIG. 6. When the student selects the take a test button 602, a screen 1600 displaying the list of available tests appears, as shown in FIG. 16. A student may only access those tests that have been enabled by the student's teacher. If a test has been enabled by the teacher, the student may choose to take that test by clicking on the take the test button 1601 that is next to the right of the test the student desires to take.

If a student has already taken a particular test, then he may click on the check your results button 1602 located next to the particular test. A screen will appear indicating the date on which the test was taken. The student's grade on the test may also appear on the screen.

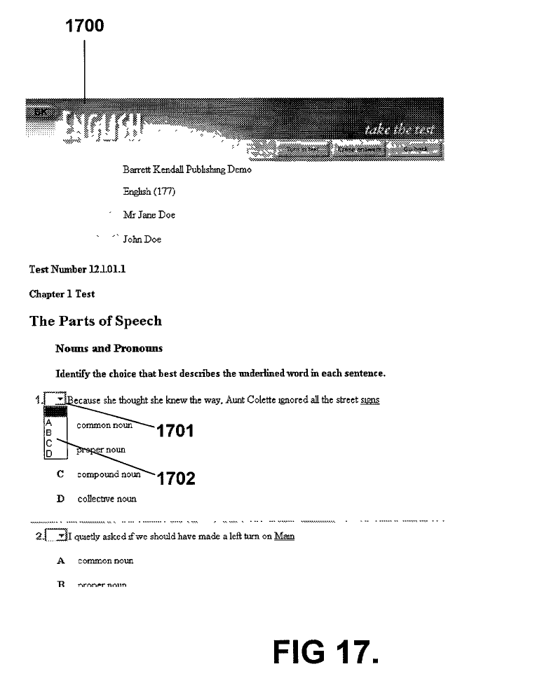

When the student clicks on a take the test button 1601, a testing screen 1700 like the one in FIG. 17 will appear. The testing screen will contain a list of questions that the student must answer. The student may answer multiple choice questions by clicking on the answer box 1701 next to the question. A drop down box 1702 listing the answer choices will then appear. A student may select an answer in the drop down box by clicking on it. In addition to multiple choice questions, the test may also contain questions, such as essay or short answer questions, that require the student to provide a written response. The test may contain response boxes where the student can type in answers to such questions.

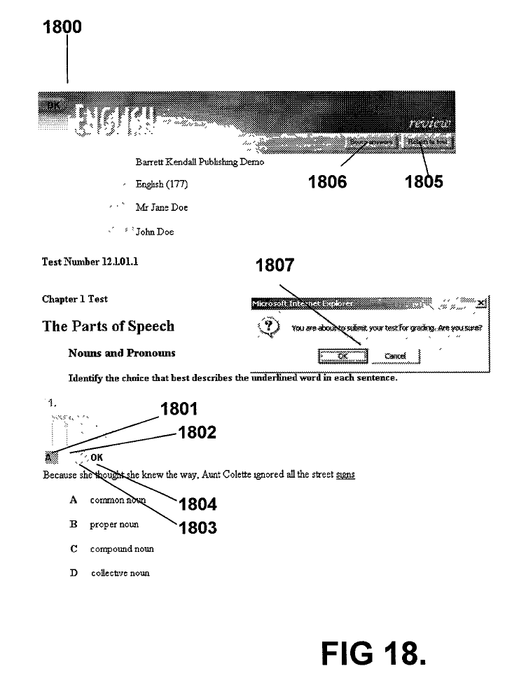

A student may choose to clear all of the answers he has entered by clicking on the erase answers button 1704. Once a student has completed the test, he may click on the turn in your test button 1703. The screen 1800 illustrated in FIG. 18 then appears. From this screen, the student may review all of the answers he entered. Four boxes appear next to each multiple choice question, a “your answer” box 1801, an “incomplete” box 1802, a “correct answer” box 1803, and a “results” box 1804. The answer the student selected for a question will appear in the your answer box 1801 next to the question. If the student did not answer a question, a question mark will appear in the incomplete box 1802 next to the question. If a student desires to change some of his answers before submitting his test to be graded, he may click on the return to test button 1805. This will return the student to the testing screen 1700, and the student will be able to change his answers. If the student does not wish to change any answers, but wishes to turn in his test to be graded, he may click on the score answers button 1806. A box 1807 may then appear asking the student if he is sure he wants to submit his answers to be graded. If the student clicks the “OK” choice in the box 1807, the multiple choice questions are automatically graded and sent electronically to the student's teacher. Additionally, any answers the student typed in are also sent electronically to the teacher.

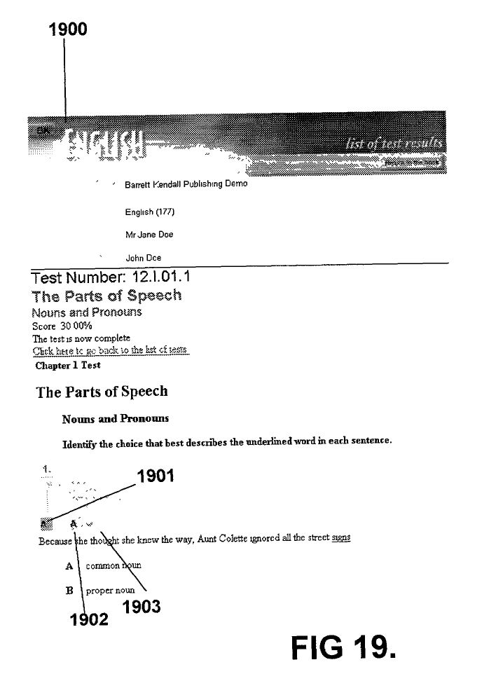

Once the student has submitted the test for grading, a screen 1900 may appear that tells the student his score on the multiple choice portion of the test and shows the correct answers to the multiple choice questions on the test. As shown in FIG. 19, the student's answer will appear in the your answer box 1901, and the correct answer to the question will appear in the correct answer box 1902. If the student answered the question correctly, a check mark may appear in the results box 1903. If the student answered the question incorrectly, an “x” may appear in the correct answer box 1903.

If a student has already taken a test, and he clicks on the check your results button 1602 next to that test on the screen 1600 shown in FIG. 16, a screen will appear that indicates the student has taken the test, and will provide the student's score if the test has been graded.

As previously stated, from the book list screen 600 illustrated in FIG. 6, the student may also choose to do skill practice exercises by clicking on the skills practice button 604. When a student clicks on the skills practice button, the screen listing the various practice tests appears. A student completes these practice tests in the same manner previously described for completing tests. However, the student's scores on the practice tests are not sent to the teacher. Instead, the tests may be intended only for the student's benefit.

Logging in as a Administrator

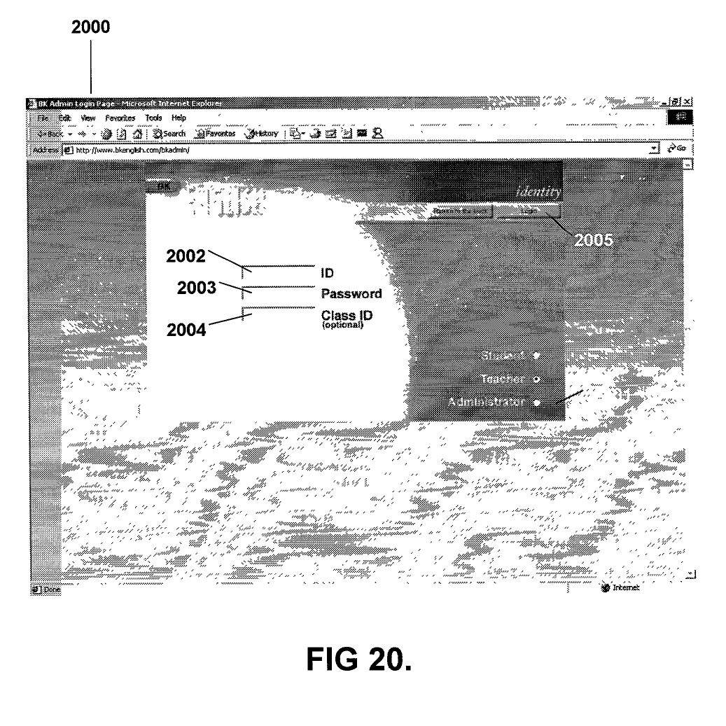

To log into the administrative site, it is first necessary to access the log-in screen by going to a specified URL address using an internet browser. An example of a log-in screen 2000 is shown in FIG. 20. The administrator first would select the Administrator option 2001, and then would enter a user ID 2002 and password 2003. An administrator may not be required to enter a class ID 2004. The administrator would then click the log-in button 2005.

Once the administrator has successfully logged into the system, a screen 2100 similar to the one shown in FIG. 21 appears. The administrator has the ability to perform several tasks, such as creating or deleting a student ID, creating or deleting a teacher ID, creating or deleting an administrator ID, updating school information, and running class summary reports. A principal of a school might, for example, be an administrator, and she would be able to log into the system as an administrator and perform these functions.

To create or delete a student ID, which may be necessary when a new student enters a class or a student leaves a class, the administrator first clicks on the students page selector 2101. To create a student ID, the administrator first enters the number of IDs she wishes to create in the provided box 2102. For instance, if the administrator desires to create IDs for three students, she would enter “3” in the provided box 2102. The administrator then clicks on the add students button 2103. The number of requested IDs then appears on the screen, as shown in FIG. 21. For each student ID 2104, the administrator then enters the student's last name 2105, first name 2106, grade level 2107, and log-in password 2108 in the spaces provided. To save the changes and enter them into the database, the administrator would click on the save button 2109.

To delete a student ID, the administrator would first locate the desired student ID. The administrator can view all the IDs of students in a single grade level by clicking on the corresponding grade level in the grade level box 2110. The administrator can scroll down though the IDs until she finds the ID she is looking for. Next she checks the delete box 2111 next to the student ID she desires to delete. Finally, she clicks on the save button 2109 and the student ID is deleted from the system. Once the student ID is removed from the system, the student's information may be permanently removed, and the student may no longer be able to log into the system.

An administrator may create or delete a teacher ID using essentially the same steps as creating or deleting a teacher ID. First the administrator must click on the teachers tab 2112. The screen 2200 shown in FIG. 22 then appears. The teacher may then create and remove teacher IDs using the steps discussed above for creating and removing student IDs. When creating a teacher ID, the administrator may be required to enter two more items of information than when she creates a student ID. First, she may enter the teacher's title in the title box 2201. Second, she may enter the teacher's e-mail address in the email box 2202. It is preferable that a teacher's e-mail address be entered into the system, because in the embodiment of the invention described herein, when a student completes a homework assignment or test, the results are submitted to the teacher via e-mail.

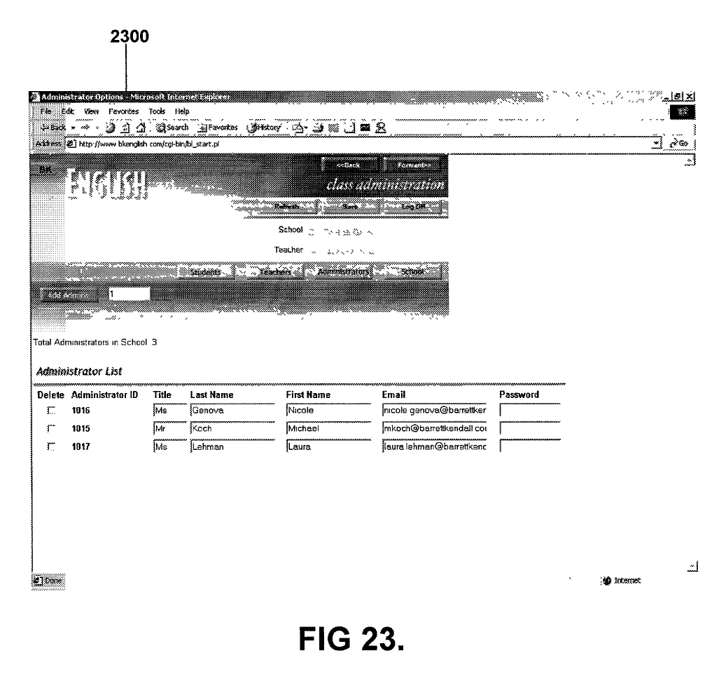

An administrator may also create or delete an administrator ID. For example, a school may have a principal and several vice-principals who may log in as administrators. If, for example, one of the vice-principals no longer worked at the school, it would be desirable for the principal to remove that vice-principal's administrator ID. To create or remove an administrator ID, the administrator first clicks on the administration tab 2113. The screen 2300 shown in FIG. 23 then appears. The administrator may create and delete administrator IDs in the same manner that she creates and deletes teacher IDs.

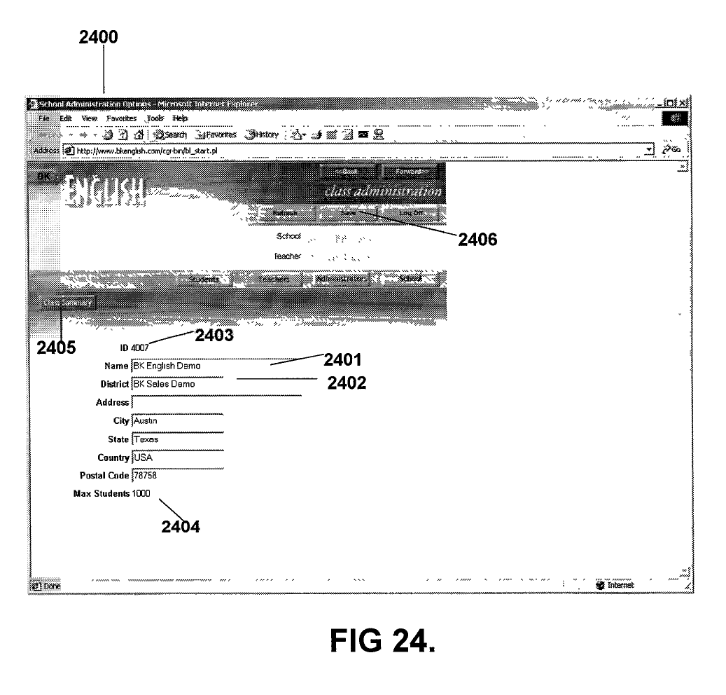

An administrator may also change school information. To do this, the administrator first clicks on the school 2114 tab. The screen 2400 shown in FIG. 24 then appears. Various fields are provided where the administrator may enter the information, such as the school name field 2401 and the school district field 2402. To save the information once it has been entered, the administrator clicks on the save button 2406. The administrator may be unable to change certain information on the screen. For instance, the school ID 2403 and the maximum student number 2404 are set by the system administrator. The school ID is unique to each school, and may be used by the system to store and identify the information relating to that school. The maximum student number is the maximum amount of students a particular school may have entered into the system.

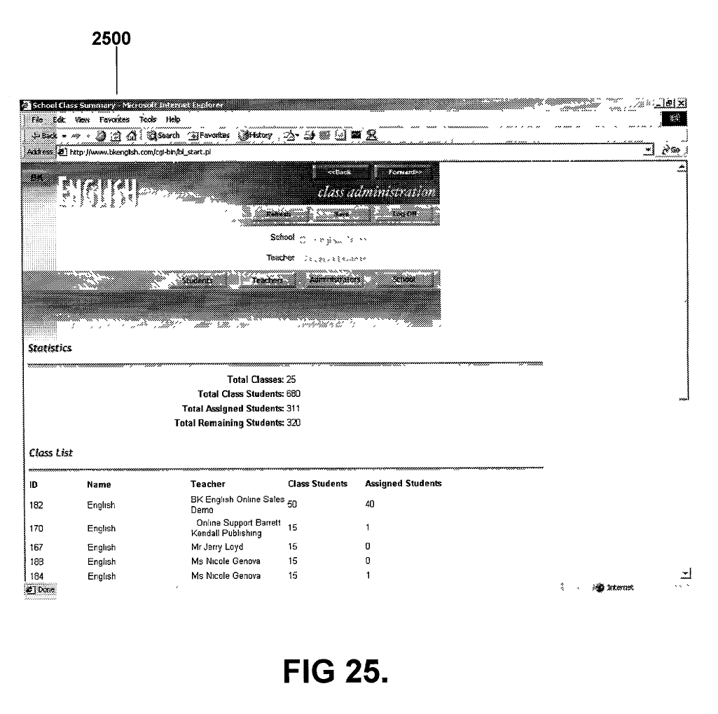

An administrator may also run a class summary report. This report lists the name of each class in the school that has been entered into the system, the class ID, the teacher, the number of students in the class, and the number of students that have been assigned a system password and I.D. To create a class summary report from the screen 2400 shown in FIG. 24, the administrator clicks on the class summary button 2405. The class summary them appears, as shown on the screen 2500 of FIG. 25.

Finally, to log out of the administrator site, the administrator may click on the log off button 2115.

Logging in as a Teacher

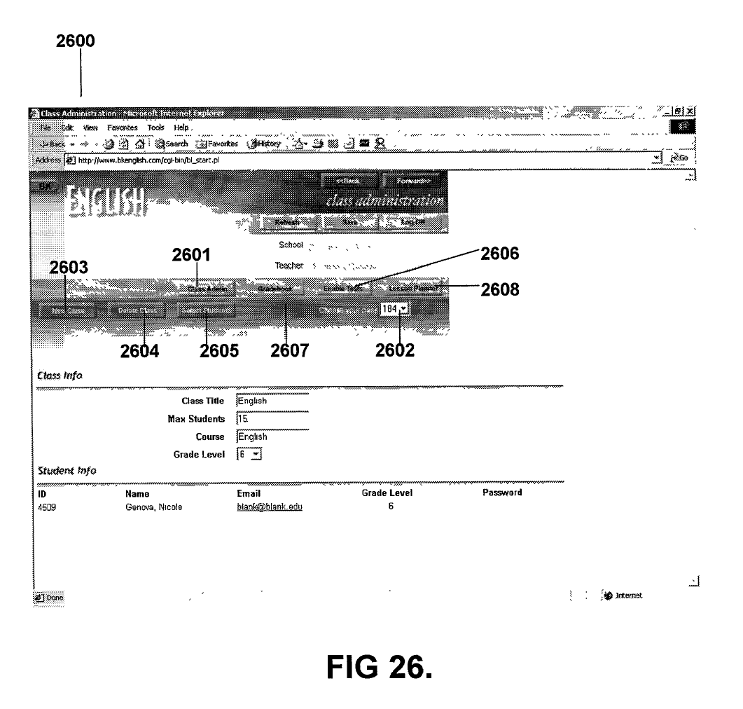

It is also possible to log into administrative site as a teacher. A teacher logs in by choosing the teacher 2006 option on the log-in screen, as shown in FIG. 20, and then enters a user ID and password. A screen similar to the screen 2600 shown in FIG. 26 may then appear. The teacher has the ability to perform several tasks, which may include creating or deleting a class ID, adding or removing students in a class, viewing a test summary for a particular class, viewing a student's test summary, viewing a gradebook, enabling a test to be taken, and creating a customized test.

A teacher may view information for one of her classes by clicking on the class administration button 2601. If a teacher teaches multiple classes, she may select the desired class by the class numbers contained in the choose your class box 2602. Various information about the students in the selected class is then displayed. This information may include the student's name, I.D., email, grade level, and password. The teacher may add or remove students from a particular class by clicking on the select students icon 2605. The teacher may add or delete classes by using the new class button 2603 and the delete class button 2604.

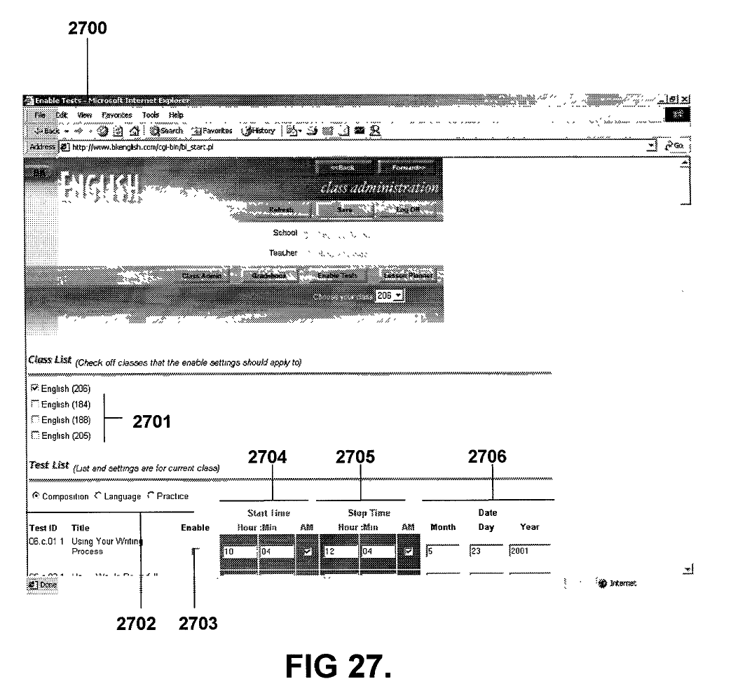

A teacher may also choose to enable a test, thereby allowing students to access the test when they log into the system. As previously stated, when a student logs in, he is not able to access a test unless the teacher has enabled the test. To enable a test, the teacher clicks on the enable test tab 2606. A screen 2700 like the one shown in FIG. 27 may then appear. The teacher may select the classes for which she desires a particular test to be enabled by checking the desired classes in the class list 2701. To view tests for a particular section of the textbook, or to view practice tests, the teacher makes the desired selection from the test selection list 2702. A list of tests available for the specified selection is then shown on the screen.

The teacher may enable a particular test by clicking on the enable box 2703 located next to the test name. A teacher may also control the time the student's have access to the test. The teacher may enter a start time in the start time boxes 2704, a stop time in the stop time boxes 2705, and a date in the date boxes 2706.

The teacher may also view grades by using the gradebook feature. A teacher may view her gradebook by clicking on the gradebook icon 2607. A screen 2800 similar to the one shown in FIG. 28 may then appear. The teacher may select the class for which she desires to view grades by selecting the class I.D. from the choose your class box 2802. Once a class has been selected, the teacher may select to view the grades in a variety of formats. These formats may include, for example, by student name, by student I.D., by test title, by test I.D., displaying raw scores, and displaying curved scores. The teacher may select the desired format by choosing the options in the format field 2801. Additionally, the teacher can select to only view grades for pre-written tests provided with the on-line textbook system, customized tests that the teacher has prepared, or for homework assignments. The teacher may make the desired selection from the content list 2803. The teacher also may also choose to only view those grades for a specific grading period. This may be achieved by selecting the desired grading period from the marking period selection box 2804.

In addition to using the pre-written tests that are provided with the on-line coursebook, a teacher may also choose to create her own custom tests. This may be accomplished by clicking on the custom tests icon 2805. The teacher may then construct her own test that will be placed on the system for the students to access. The customized test may be enabled in the manner previously described.

The teacher may also create and view a lesson planner. The lesson planner may be view by clicking on the lesson planner icon 2608.

Those skilled in the art will recognize that other features useful to teachers may easily be added to the present system. For instance, a lesson planner may be added that allows the teacher to create and keep her lesson plans on the system.

Remarks

Unlike other attempts to provide online textbooks, which have been provided using text or html files, the present invention provides a system has the exact same look and feel as the book. However, the present invention is more useful because there are embedded hyperlinks, homework, and testing, all within the framework of the PDF document.

1. A course support system for providing an on-line course support service to a plurality of users, the users having a computer with a browser and an electronic reader program for viewing an electronic reader file, comprising:
(a) a course support server having a course support program for providing an on-line course book to the users, wherein the server provides to the users one or more electronic reader files having course book content to be displayed by the electronic reader program, the course book content corresponding to a requested portion of the course book; and
(b) a database server operably coupled to the course support server for providing it with the one or more electronic reader files, wherein at least one of the electronic reader files include one or more executable instructions for verifying that the user is connected to the course support server in order for the one or more files to be displayed.

2. The apparatus of claim 1, wherein the electronic reader program is Acrobat Reader and the electronic reader format is a PDF file format.

3. The system of claim 1, wherein at least one of the electronic reader files includes a link for allowing a user to view additional web pages related to the course book content in the one or more electronic reader files, wherein the link maps to a network address stored in the database server.

4. The system of claim 1, wherein the course support program is implemented with one or more software engines for performing course support functions for the plurality of users.

5. The system of claim 4, wherein the one or more engines are implemented with server side common gateway interface programs.

6. A course support system for providing an on-line course support service to a plurality of student users having a computer with an electronic reader program for viewing an electronic reader file, comprising: a course support server having a course support program for providing an on-line course book to the users, the course support program including:
(i) a books engine for providing to the users one or more electronic reader files having course book content corresponding to pages in a printed classroom course book, the one or more electronic reader files to be opened by the electronic reader program for displaying the course book pages to the student users; and
(ii) a homework engine for (1) presenting, in response to a request from a student user, a homework exercise associated with the pages displayed to the user, (2) providing to the user a writeable workspace for completing the exercise, and (3) receiving from the user the completed exercise.

7. The system of claim 6, wherein the homework engine automatically transmits the completed homework exercise to an instructor user associated with the student user.

8. The system of claim 7, wherein the homework engine automatically transmits the completed homework to an e-mail account of the instructor user, wherein the student user need not have access to the e-mail account.

9. The system of claim 6, wherein substantially all of the one or more electronic reader files have executable instructions that are executed by the electronic reader program when it opens an electronic reader file, the executable instructions preventing the course book content from being displayed to the student user unless it is connected to the course support server.

10. The system of claim 9, wherein the electronic reader files are PDF files, the electronic reader program includes an Adobe Acrobat Reader program, and the instructions include Java script instructions that cause the Acrobat Reader program to check for a valid global variable set by the course support server before displaying the course book content to the student user.

11. The system of claim 6, wherein a student user requests course book pages from the course support server by submitting a request to the server that invokes the books engine to service the course book pages request as long as the server confirms that the user has a valid access key, which is initially provided to the student user when it logs onto the course support server.

12. A course support system for providing an on-line course support service to a plurality of student users having a computer with an electronic reader program for viewing an electronic reader file, comprising: a course support server having a course support program for providing an on-line course book to the users, the on-line course book corresponding to a printed classroom course book, the course support program having executable instructions that when executed by the server:
(i) receive a login request from a user;
(ii) transmit to the user an access key if the user is valid;
(iii) receive a request from the user to view a selected one or more pages from the online course book;
(iv). determine whether the user has the valid access key; and
(v). provide to the user one or more electronic reader files having course book content corresponding to the one or more requested pages if the user has the valid access key.

13. The system of claim 12, wherein the access key is transmitted to the user via an encrypted session cookie.

14. The system of claim 12, wherein substantially all of the one or more electronic reader files have executable instructions to be executed by the user's electronic reader program for displaying the requested one or more pages, wherein the executed instructions cause the electronic reader program to verify that the user is connected to the course support server before displaying the content to the user.

15. The system of claim 12, wherein the user logs onto the server through an Internet browser, wherein the server transmits back to the user a web page that provides the user with on-line course book options, wherein the web page includes instructions for inhibiting the user from navigating outside of the course support server.

16. A course support system for providing an on-line course book to a plurality of student users having a computer with an electronic reader program for viewing an electronic reader file, comprising: a course support server having a course support program for providing the on-line course book, the course support program including:
(i) a books engine for providing to the users one or more electronic reader files having course book content corresponding to pages in a printed classroom course book, the one or more electronic reader files to be opened by the electronic reader program for displaying the course book pages to the student users; and
(ii) a test engine for (1) presenting to a student user a test associated with the pages displayed to the user, (2) receiving from the user responsive test answers, and (3) scoring the test and automatically providing the score to an instructor user.

17. The system of claim 16, wherein the test engine provides to the instructor user the ability to control the availability of the test.

18. The system of claim 16, wherein the on-line course book pages appear substantially like the corresponding printed course book pages.

19. The system of claim 16, wherein the electronic reader files include executable instructions for displaying to the student user links that allow the user to view additional materials related to he displayed course book pages.

20. A method for providing an on-line course book, comprising:
(a) responsive to an Internet request from a user, providing a web page for logging onto a course support server;
(b) validating the user upon receiving its login request;
(c) providing to the user one or more electronic reader files for display in an electronic reader program, the files having course book content corresponding to one or more course book pages requested by the user, the course book pages when displayed on the reader program substantially appearing as pages from a corresponding printed course book; and
(d) embedding within at least one of the electronic reader files executable instructions that will cause the displayed pages to have a link that allows the user to view additional materials related to the content of the displayed at least one page.
